(19) United States
(12) Patent Application Publication
(10) Pub. No.: US 2026/0132484 A1
(43) Pub. Date: May 14, 2026

(54) ELECTROCHEMICAL METALLURGICAL SLAG RECYCLING

(71) Applicant: ELECTRASTEEL, INC., Boulder, CO (US)

(72) Inventors: Ai Quoc PHAM, Boulder, CO (US); Steven FATUR, Boulder, CO (US); Philip WAGNER, Boulder, CO (US); Adolfredo ALVAREZ, Boulder, CO (US)

(73) Assignee: ELECTRASTEEL, INC., Boulder, CO (US)

(21) Appl. No.: 19/106,035

(22) PCT Filed: Sep. 18, 2023
(86) PCT No.: PCT/US2023/033007

§ 371 Date: Feb. 24, 2025

Related U.S. Application Data
(60) Provisional application No. 63/407,998, filed on Sep. 19, 2022.
(60) Provisional application No. 63/408,034, filed on Sep. 19, 2022.

(51) Int. Cl. C22B 7/04; C22B 7/00; C25B 1/04; C25D 3/20; C25D 17/00

(52) U.S. Cl. CPC C22B 7/04; C22B 7/007; C25B 1/04; C25D 3/20; C25D 17/002

(57) ABSTRACT

Described herein are various aspects of systems and methods for extracting and isolating re-usable materials from a metallurgical slags such as iron slag, steel slag, blast furnace slag, BOF slag, and/or EAF slag using aqueous acid and base solutions. In some aspects, the acid and base solutions or materials may be produced electrochemically in a salt-splitting acid-base generation (ABG) cell or cell-stack.

### CROSS-REFERENCE TO RELATED APPLICATIONS

This application claims the benefit of priority to U.S. Provisional Patent Application No. 63/407,998, filed Sep. 19, 2022, and U.S. Provisional Patent Application No. 63/408,034, filed Sep. 19, 2022, each of which is hereby incorporated by reference in its entirety.

### BACKGROUND

This application relates generally to the field of metallurgy, and more particularly to systems and methods for recycling industrial byproducts such as metallurgical slag into reusable materials.

Currently, steel is conventionally made by one of two processes: the “integrated” process and the “electric arc furnace” or EAF process. In the integrated process, iron ore is refined to pig iron in a “blast furnace” and the (typically still molten) pig iron is then transferred to a “basic oxygen furnace” (BOF) in which it is converted into steel by removal of excess carbon and addition of alloying elements. In the EAF process, scrap steel, scrap iron, pig iron, direct-reduced iron, and/or other iron-containing materials are melted by an electric arc between graphite electrodes. In both the BOF and EAF processes, impurities are removed by forming a “slag” material made up of molten impurities. The slag floats on top of the molten iron, allowing the iron and slag to be separated from one another, thereby allowing for creation of a pure steel product from the molten iron.

Slag is typically formed, in part, by the addition of “flux” materials, mostly made up of carbonates and/or oxides of calcium and/or magnesium. The flux materials melt and bond with impurities (e.g., silica, alumina, phosphorus, and metal oxides) to form lower-density compounds. Flux materials may also provide a protective layer on furnace refractory materials to minimize or prevent damage to the refractory.

In various applications, naturally occurring limestone (CaCO₃) and/or dolomite (CaMg(CO₃)₂) minerals are frequently used as flux in steelmaking. In other cases, lime (CaO), magnesia (MgO), magnesite (MgCO₃), brucite (Mg(OH)₂, or mixtures of one or more calcium and/or magnesium carbonates, and/or calcium and/or magnesium oxides (including hydroxides) may be used as flux in steelmaking. In some cases, flux materials may also contain other elements or compounds as impurities, such as silica, iron oxides, sulfur compounds, or phosphorus oxides.

Iron and steel slags can be broadly classified into “blast furnace slag” that is generated when iron ore (naturally-occurring rocks containing substantial quantities of iron oxide) is melted and chemically reduced to remove oxides in a blast furnace, “steelmaking slag” that is generated during the steelmaking processes used to modify the components of iron, and “ladle slag” that is produced to assist final refinement of molten steel immediately prior to casting.

Blast furnace slag is a combination of silica and other non-ferrous components of iron ore, ash from coke used as a reducing material, and limestone auxiliary material. Because its specific gravity is less than that of pig iron, during the heating process the molten slag rises above the pig iron allowing it to be easily separated and recovered.

Steelmaking slag is generated when converting pig iron from a blast furnace into tough and highly workable steel. Converter slag (or BOF slag) is the oxidized material that is generated when lime and other auxiliary materials are added and oxygen is blown onto the pig iron to remove carbon, phosphorous, sulfur, and other components from the pig iron and refine it to produce strong steel. Another type of steelmaking slag, “electric arc furnace slag,” is generated when iron scrap and metallic iron typically as ore-based metals (OBMs) such as pig iron, direct-reduced iron (DRI), hot briquetted iron (HBI), and/or other OBMs or other materials containing predominantly metallic iron are melted and refined in an EAF.

The particular composition (i.e., presence, quantity, and crystal state of elements and compounds) of a steel slag material will tend to vary based on the type of furnace used, composition of iron-source materials melted in the furnace, type and grades of steel produced, and even individual furnace materials and operating practices. Nonetheless, steel slags may contain compounds such as CaO, MgO, SiO₂, FeO, Fe₂O₃, Fe₃O₄, Al₂O₃, MnO, P₂O₅, TiC₂, and sulfur compounds such as CaS, among other possible compounds. Much of that material is often in the form of calcium silicates, calcium alumino-ferrites, and fused oxides of calcium, iron, magnesium, and manganese.

The global steel industry produces nearly 300 million tons of steel slag each year, about 0.3 ton of slag per ton of steel produced. Some jurisdictions have discussed classifying some slag materials as hazardous waste, which would dramatically increase the cost of its transportation and disposal. Some steel slag is used as aggregate in cement making or as road base material, but the industry as a whole has difficulty finding sufficient demand for the volume of slag produced. Therefore, methods for more effectively re-using steel slags and iron slags are needed.

### SUMMARY

Described herein are various aspects of systems and methods for extracting and isolating re-usable materials from a metallurgical slags such as iron slag, steel slag, blast furnace slag, BOF slag, and/or EAF slag using aqueous acid and base solutions. In some aspects, the acid and base solutions or materials may be produced electrochemically in a salt-splitting acid-base generation (ABG) cell or cell-stack.

Aspects disclosed herein include methods (and systems for performing the methods) of recycling a first slag, the methods comprising: dissolving the first slag with a first acid to form a starting leachate solution; wherein the starting leachate solution comprises at least dissolved (aqueous) aluminum ions, dissolved iron ions, dissolved (aqueous)magnesium ions, and dissolved (aqueous)manganese ions; first precipitating one or more first precipitated products from the starting leachate solution by combining a first base with the starting leachate solution to increase its pH thereby forming a first pre-plating leachate fraction; wherein the one or more first precipitated products comprise one or more precipitated aluminum-containing products; wherein the first pre-plating leachate fraction comprises dissolved (aqueous) iron ions, magnesium ions, and manganese ions; first electroplating metallic iron from the first pre-plating leachate fraction using a first electrochemical cell, forming electroplated metallic iron and a first post-plating leachate fraction; wherein the first post-plating leachate fraction has a reduced concentration of said iron ions compared to the first pre-plating leachate fraction; second precipitating one or more second precipitated products from the first post-plating leachate fraction by combining a second base with the first post-plating leachate fraction to increase its pH thereby forming a second leachate fraction; wherein the one or more second precipitated products comprise one or more precipitated manganese-containing products; and third precipitating one or more third precipitated products from the second leachate fraction by combining a third base with the second leachate fraction to increase its pH thereby forming a third leachate fraction; wherein the one or more third precipitated products comprise one or more precipitated magnesium-containing products.

### BRIEF DESCRIPTION OF THE DRAWINGS

FIG. 1 is a schematic block diagram illustrating a process for recycling metallurgical slag to extract re-usable materials using electrochemically-produced acid and base solutions.

FIG. 2 is a schematic block diagram illustrating a process for recycling metallurgical slag, including an electroplating cell configured to electroplate iron from the leach solution containing ions of Mg, Ca, Mn, and/or other ions.

FIG. 3 is a schematic block diagram illustrating the recycling of slag from a steelmaking plant into components re-usable in the steelmaking plant.

FIG. 4 is a schematic illustration of an example electrochemical acid-base generation cell.

FIG. 5 is a schematic illustration of an iron electroplating cell for electroplating metallic iron from an aqueous solution containing ferrous iron (Fe²⁺ ions).

FIG. 6 is a schematic diagram illustrating other configurations of an electrochemical acid-base generation system.

FIG. 7 is a schematic diagram illustrating other configurations of an electrochemical acid-base generation system.

FIG. 8 is a schematic diagram illustrating an example electrodialytic cell for producing acid and base using bipolar membranes.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of this disclosure.

In various aspects, the present disclosure provides processes, systems, and methods for recycling steel slag into value-added materials using electrochemically-produced acid and base solutions, creating a circular economy for steel production. In various aspects described herein, components of steel slag may be isolated and formulated for use as CO₂ capture materials, as steelmaking flux materials, or other uses.

In various aspects, the present disclosure provides processes, systems, and methods for enabling efficient, low-temperature aqueous hydrometallurgical processes for producing pure iron from various iron source materials including relatively low-purity iron feedstock materials. In broad terms, an iron feedstock material is dissolved in an acidic aqueous solution, and metallic iron is electrolytically plated and removed as a solid. In various aspects, iron feedstock materials or aqueous iron may be converted from one form to another during one or more process steps.

As used herein, the terms “pure iron” and “high purity iron” are used in a relative sense to refer to a metallic iron material that is more pure than an iron source material, and contains an acceptably low quantity of one or more impurities.

As used herein, the terms “iron source material” and “iron feedstock” are used synonymously to refer to iron-containing materials that may be used as inputs into the various systems and methods described herein. “Iron source materials” and “iron feedstocks” may include iron in any form, such as iron oxides, hydroxides, oxyhydroxides, carbonates, or other iron-containing compounds, ores, rocks or minerals, including any mixtures thereof, in naturally-occurring states or beneficiated or purified states. The term “iron-containing ore” or simply “iron ore” may include materials recognized, known, or referred to in the art as iron ore(s), rock(s), natural rock(s), sediment(s), natural sediment(s), mineral, and/or natural mineral(s), whether in naturally-occurring states or in beneficiated or otherwise purified or modified states. Some aspects of processes and systems described herein may be particularly useful for iron ores including hematite, goethite, magnetite, limonite, siderite, ankerite, turgite, bauxite, or any combination thereof.

Optionally, an iron source material or iron feedstock may comprise an iron metal material, such as, but not limited to, iron dust (e.g., fine particulate produced as a byproduct of ironmaking or steelmaking processes in blast furnaces, oxygen furnaces, electric arc furnaces, etc.), iron powder, scrap steel, and/or scrap cast iron. “Iron source materials” and “iron feedstocks” may also contain various other non-iron materials, generally referred to as “impurities.”

As used herein, the term “impurity” refers to an element or compound other than a desired final product material (e.g., iron). In various aspects, depending on the intended end-use of a product material, a given element or compound may or may not be considered an “impurity.” In some cases, one or more elements or compounds that may be impurities to one process or sub-process may be isolated or purified, collected, and sold as a secondary product material.

In various aspects herein, various compositions, compounds, or solutions may be substantially “isolated” or “purified” to a degree sufficient for the purposes described herein. In various aspects, a substantially purified composition, compound or formulation (e.g., ferrous iron solutions, ferric iron solutions, or plated metallic iron) may have a chemical purity of 90% (e.g., by molarity of ionic concentrations or by weight), optionally for some applications 95%, optionally for some applications 99%, optionally for some applications 99.9%, optionally for some applications 99.99%, and optionally for some applications 99.999% pure.

Reference made herein to a “tank” is intended to include any vessel suitable for containing liquids, such as highly acidic or caustic aqueous solutions if needed. In some aspects, such a vessel may include additional features or components to assist or improve mixing of solid and/or liquid contents of the vessel. For example, a dissolution tank may include passive or actively operated structures or features for agitating a solution or solid/liquid mixture. A dissolution tank or other tank useful in the systems and methods herein may also include features to allow for sparging a gas into or through solid and/or liquid contents of the tank to increase gas contact with solid and/or liquid materials within the tank. Various tanks may also include baskets, sieves, pans, filters, or other structures to collect and separate solids from liquids. In some aspects, a tank may be configured to direct liquid or gas flow through the tank in such a way as to agitate the mixture therein (e.g., flow-directing structures, pumps, impellers, baffles, impellers, stir-bars, stir blades, vibrators, cyclonic flow channels, etc.).

In some aspects described herein, a system for converting iron ore into iron metal (i.e., an “iron conversion system”) may comprise two or more subsystems. Some aspects include a “dissolution subsystem” in which components of an iron-containing feedstock are dissolved into an aqueous solution. Some aspects further include an “iron plating subsystem” in which dissolved iron is electrochemically reduced to iron metal in an “electroplating” (or simply “plating”) process. The iron metal may subsequently be removed from the iron plating subsystem.

In some aspects, an aqueous iron-containing solution may be transferred to and treated in a “transition subsystem” after leaving the dissolution subsystem and before being delivered to the plating subsystem. Treatments within the transition subsystem may include pH adjustment, impurity removal, filtration, or other processes. In some aspects, any of the above sub-systems may be fluidically coupled to one another by an “inter-subsystem fluidic connection” which may comprise any combination of fluid-carrying conduits (pipes, channels, troughs, etc.) and any number of flow control devices, including valves, pumps, expansion chambers, gas-liquid separators, solid-liquid separators, filters, or other similar devices.

The term “iron electroplating” (or “iron plating” as used synonymously herein) refers to a process by which dissolved iron is electrochemically reduced to metallic iron on a cathodic surface. Equivalent terms “electrodeposition,” “electroforming,” and “electrowinning” are also used herein synonymously with “iron electroplating.” The shape or form-factor of the electroplated iron need not be a “plate” by any definition of that term. For example, electroplated iron may take any shape or form and may be deposited on any suitable cathodic surface as described in various aspects herein.

The term “dissolution step” includes processes occurring in the dissolution subsystem, including but not limited to dissolution of iron oxide materials and electrochemical process(es) occurring in or via an “acid regeneration cell,” including but not limited to the claimed step of electrochemically reducing Fe³⁺ ions to Fe²⁺ ions in the acid regeneration cell. Dissolution step processes may also include oxidizing water or hydrogen gas in the first electrochemical cell, for example, to generate protons, which may allow for regeneration of the acid (in the form of protons) that is used to facilitate dissolution of an iron-containing feedstock.

The term “iron plating step” includes process(es) occurring in the iron plating subsystem, including but not limited to the electrochemical process(es) occurring in or via the claimed “plating cell,” including but not limited to the step of “electrochemically reducing” Fe²⁺ ions to Fe metal in the “plating cell” also referred to herein as the “plating cell.” The iron plating process may also include oxidizing a second portion of Fe²⁺ ions to form Fe³⁺ ions. In some aspects, such Fe²⁺ ions may be provided from the first electrochemical cell or from another part of the system.

As used herein, unless otherwise specified, the terms “ferrous iron solution” or “ferrous solution” may refer to an aqueous solution that contains dissolved iron that is at least predominantly (i.e., between 50% and 100%) in the Fe²⁺ (i.e., “ferrous”) ionic state with the balance of dissolved iron being in the “ferric” Fe³⁺ state. Similarly the term “ferrous ion” refers to one or more ions in the ferrous (Fe²⁺) state.

As used herein, unless otherwise specified, the terms “ferric iron solution” or “ferric solution” may refer to an aqueous solution that contains dissolved iron that is at least predominantly (i.e., between 50% and 100%) in the Fe³⁺ (i.e., “ferric”) ionic state with the balance of dissolved iron being in the “ferrous” Fe²⁺ state. Similarly the term “ferric ion” refers to one or more ions in the ferric (Fe³⁺) state. Either “ferric solutions” or “ferrous solutions” may also contain other dissolved ions or colloidal or particulate materials, including impurities.

As used herein, any reference to a “PEM” or “proton exchange membrane” may be interpreted as also including a “CEM” or “cation exchange membrane”, both terms may include any available membrane material that selectively allows passing positively charged cations and/or protons. The abbreviation “AEM” is used to refer to anion exchange membranes selective to negatively-charged aqueous ions and includes any available anion-selective membrane.

As used herein, aqueous protons and electrochemically generated protons are intended to be inclusive of aqueous protons and aqueous hydronium ions.

As used herein, the term “unprocessed ore” refers to an iron-containing ore that has been neither thermally reduced nor air roasted according to aspects disclosed herein. Unprocessed ore is optionally a raw iron-containing ore.

As used herein, electrochemically generated ions, such as electrochemically generated protons and electrochemically generated iron ions (e.g., Fe²⁺, Fe³⁺), refer to ions that are generated or produced in an electrochemical reaction. For example, electrochemical oxidation of water at an anode may electrochemically generated protons and electrochemically generated oxygen.

As used herein, the term “thermally reducing” refers to a thermal treatment at an elevated temperature in the presence of a reductant. Thermal reduction is also referred to in the art as reduction roasting. Optionally, thermal reduction is performed at a temperature selected from the range of 200° C. and 600° C. Optionally, the reductant is a gas comprising hydrogen (H₂) gas. Additional description and potentially useful aspects of thermal reduction may be found in the following reference, which is incorporated herein in its entirety: “Hydrogen reduction of hematite ore fines to magnetite ore fines at low temperatures”, Hindawi, Journal of Chemistry, Volume 2017, Article ID 1919720.

As used herein, the term “parasitic hydrogen” or hydrogen (H₂) from a “parasitic hydrogen evolution reaction of an iron electroplating process” refers to hydrogen (H₂) gas electrochemically generated by a side reaction concurrently with an iron electroplating reaction (e.g., Fe²⁺ to Fe or Fe³⁺ to Fe²⁺ to Fe) in the same electrochemical cell. Additional description and potentially useful aspects of pertaining to parasitic hydrogen evolution may be found in the following reference, which is incorporated herein in its entirety: “An investigation into factors affecting the iron plating reaction for an all-iron flow battery”, Journal of the Electrochemical Society 162 (2015) A108.

As used herein, the term “air roasting” refers to a thermal treatment performed at an elevated temperature in the presence of air. Air roasting of ore, such as iron-containing ore, can break down or decrease average particle size of an ore. Optionally, air roasting is performed at temperature selected from the range 300° C. and 500° C. Additional description and potentially useful aspects of air roasting may be found in the following reference, which is incorporated herein in its entirety: “Study of the calcination process of two limonitic iron ores between 250° C. and 950° C.”, Revista de la Facultad de Ingeneria, p. 33 (2017).

As used herein, the term “redox couple” refers to two chemical species, such as ions and/or molecules, that correspond to a reduced species and an oxidized species of an electrochemical reaction or a half-cell reaction. For example, in the electrochemical reduction of Fe³⁺ ions to Fe²⁺ ions, the corresponding redox couple is Fe³⁺/Fe²⁺, where Fe³⁺ is the oxidized species and Fe²⁺ is the reduced species. As used herein, the order in which a redox couple is described (e.g., Fe³⁺/Fe²⁺ vs. Fe²⁺/Fe³⁺) is not intended to denote which species is the reduced species and which is the oxidized species. Additional description and potentially useful aspects of redox couples may be found in the following reference, which is incorporated herein in its entirety: “Redox—Principles and Advanced Applications”: Book by Mohammed Khalid, Chapter 5: Redox Flow Battery Fundamental and Applications.

As used herein, the terms “steady state” and “steady-state” generally refer to a condition or a set of conditions characterizing a process, a method step, a reaction or reactions, a solution, a (sub)system, etc., that are true longer than they are not true during operation or performance of the process, method step, reaction or reactions, solution, (sub)system, etc. For example, dissolution of an ore or feedstock may be characterized by a steady state condition, wherein the steady state condition is true during at least 50%, optionally at least 60%, optionally at least 70%, optionally at least 80%, optionally at least 90%, optionally at least 95% of a time during which the dissolution is occurring. For example, a steady state condition may be exclusive of conditions characterizing the transient start-up and shut-down phases of a process such as dissolution of a feedstock.

The term “cathodic chamber” refers to a region, compartment, vessel, etc. comprising a cathode, or at least a portion or surface thereof, and a catholyte. The term “anodic chamber” refers to a region, compartment, vessel, etc. comprising an anode, or at least a portion or surface thereof, and an anolyte.

As used herein, the term “iron-rich solution” may be also referred to as an “iron iron-rich solution” or a “ferrous product solution”, corresponding to the iron ion-rich solution formed in the ore dissolution subsystem.

As used herein, the term “ore dissolution subsystem” may also be referred to as the “dissolution subsystem”, “first subsystem”, and “STEP 1.” The “dissolution subsystem” comprises the “acid regenerator” described herein.

As used herein, the term “iron-plating subsystem” may also be referred to as the “second subsystem” and “STEP 2.”

As used herein, the term “precipitation pH” refers to a pH at which the referenced one or more ions or salts are thermodynamically favored or expected to precipitate out of the host aqueous solution. Generally, the solubility of ions and salts dissolved in an aqueous solution may depend on the pH of the aqueous solution. As pH increases in the acidic region, many metallic ions form metal hydroxides which tend to precipitate out of the host solution due to decreasing solubility. The precipitation pH is defined herein as the pH corresponding to a point where solubility of a given ion or salt is below a concentration threshold. The precipitation pH may be an upper boundary beyond which the solubility of a given ion or salt is less than 1 mM, optionally less than 0.1 mM.

As used herein, the term “metallic iron” refers to a material comprising metallic iron, such as but not limited to scrap iron, electroplated iron, iron powder, etc.

As used herein, the term “supporting salt” and “supporting ion” refers to a salt and ion, respectively, corresponding to or serve as a supporting electrolyte or which form, at least partially, a supporting electrolyte when dissolved in order to increase a conductivity of a host solution. In some aspects, for example, the electrolytes and solutions in either the dissolution subsystem and the plating subsystem may contain dissolved iron species, acid, and additionally inert salts serving as supporting electrolyte to enhance the electrolyte conductivity, which may be particularly beneficial at low ferrous concentrations, wherein the inert salts serving as supporting electrolyte to enhance conductivity may be referred to as supporting salts. Supporting salts may include any electrochemically inert salt such as sodium chloride, potassium chloride, ammonium chloride, sodium sulfate, potassium sulfate, ammonium sulfate, sodium chloride, potassium chloride, ammonium chloride or others, or combinations of salts. The concentration of the supporting salts in the solution, if used, may range from about 0.1 to about 1 M, for example.

As used herein, the term “wt. %” or “wt %” refers to a weight percent, or a mass fraction represented as a percentage by mass. The term “at. %” or “at %” refers to an atomic percent, or an atomic ratio represented as a percentage of a type of atom with respect to total atoms in a given matter, such as a molecule, compound, material, nanoparticle, polymer, dispersion, etc. The term “mol. %” refers to molar percent or percent by moles. The term “vol. %” refers to volume percent.

The terms “substantially” and “approximately” are used interchangeably and refer to a property, condition, or value that is within 20%, 10%, within 5%, within 1%, optionally within 0.1%, or is equivalent to a reference property, condition, or value. In aspects, the terms “substantially” and “approximately” are used interchangeably and refer to a property, condition, or value that is within 20% of a reference property, condition, or value. The term “substantially equal”, “substantially equivalent”, “substantially unchanged”, “approximately”, and “approximately equal to” when used in conjunction with a reference value describing a property or condition, refers to a value that is within 20%, within 10%, optionally within 5%, optionally within 1%, optionally within 0.1%, or optionally is equivalent to the provided reference value. For example, a diameter is approximately equal to 100 nm (or, “is approximately 100 nm”) if the value of the diameter is within 20%, optionally within 10%, optionally within 5%, optionally within 1%, within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value. As used herein, the term “about” means a range of values including the specified value, which a person of ordinary skill in the art would consider reasonably similar to the specified value. In aspects, about and approximately mean within a standard deviation using measurements generally acceptable in the art. In some aspects, about means a range extending to +/−10% of the specified value. In embodiments, about means the specified value. In aspects, the terms “about”, “approximately”, and “substantially” are interchangeable and have identical means. For example, a particle having a size of about 1 μm may have a size is within 20%, optionally within 10%, optionally within 5%, optionally within 1%, optionally within 0.1%, or optionally equal to 1 μm.

As used herein, the term “and/or” is used herein, in the description and in the claims, to refer to a single element alone or any combination of elements from the list in which the term and/or appears. For example, a listing of two or more elements having the term “and/or” is intended to cover aspects having any of the individual elements alone or having any combination of the listed elements. For example, the phrase “element A and/or element B” is intended to cover aspects having element A alone, having element B alone, or having both elements A and B taken together. For example, the phrase “element A, element B, and/or element C” is intended to cover aspects having element A alone, having element B alone, having element C alone, having elements A and B taken together, having elements A and C taken together, having elements B and C taken together, or having elements A, B, and C taken together.

As used herein, the term “±” refers to an inclusive range of values, such that “X±Y,” wherein each of X and Y is independently a number, refers to an inclusive range of values selected from the range of X−Y to X+Y. In the cases of “X±Y” wherein Y is a percentage (e.g., 1.0±20%), the inclusive range of values is selected from the range of X-Z to X+Z, wherein Z is equal to X•(Y/100). For example, 1.0±20% refers to the inclusive range of values selected from the range of 0.8 to 1.2.

As used in this description, the term “consisting essentially of” is used to describe products that are predominantly made up of the specified material or materials with a small portion of other materials which may or may not be specified. For example, in some aspects “a product consisting essentially of” a specified compound (e.g., Fe(OH)₂) may describe a product of which the specified compound accounts for at least 90% of the product mass, the balance being made up of other specified or unspecified materials. In other aspects, the specified compound may account for 95%, 98%, 99%, 99.9%, or more of the mass of the identified product. Any use of the phrase “consisting essentially of” in this description is intended to include all of these aspects unless specified otherwise.

Ordinal terms such as “first,” “second,” and “third” are used in various examples and aspects herein. It should be understood that these terms are used merely for convenience within the description herein and are not intended to preclude other steps or products before, between, or after any step or product referred to with an ordinal name.

### DETAILED DESCRIPTION

In the following description, numerous specific details of devices, device components and methods are set forth to provide a thorough explanation of the precise nature of the various inventions described herein. It will be apparent, however, to those of skill in the art that the various inventions can be practiced without these specific details. Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, aspects of devices and methods may nonetheless be operative and useful.

### Refining and Recycling Metallurgical Slags

Various aspects of systems and methods for extracting and isolating re-usable materials and compounds from metallurgical slags and other input materials are provided herein. While some examples are described with reference to steel slag, other slags and materials may also be used, including blast furnace slag, BOF slag, ladle slag, EAF slag, and others. For example, various aspects described herein may also be used with inputs including slags, clays, kaolins, metakaolin, pumice, pozzolans, mafic rocks, and/or ultramafic rocks, olivine, pyroxene, amphibole, serpentine, wollastonite, peridotite, talc, biotite, basalt, hematite, magnetite, goethite, taconite, bauxite, diabase, gabbro, limestone, dolomite, calcium silicates, wollastonite, coal ash, fly ash, bottom ash, ponded ash, incinerator ash, economizer ash, or any combination of these or other materials.

In various aspects, the slag or other input material(s) may be dissolved/leached in an aqueous acid to produce a slag leach solution, and various components may be extracted from the slag leach solution by selective precipitation following a pH shift induced by addition of an aqueous base solution and/or a solid soluble base material to the slag leach solution. Alternatively, components may be selectively removed from the leach solution by other processes such as electrowinning (also referred to herein as electroplating), recrystallization, cementation, or other methods.

### Production of Acid and Base

In some aspects and examples described herein, the “acid” and “base” used for leaching and/or pH shifting are described as being produced in an electrochemical acid-base generation cells (or cell-stacks). However, any of the processes, aspects, or examples described herein may alternatively be performed using acid or base materials or solutions obtained from other sources, including the process itself. For example, in various aspects, processes are described herein for obtaining solid hydroxide materials (base materials) such as Ca(OH)₂, Mg(OH)₂, Fe(OH)₂, Fe(OH)₃, Al(OH)₃, Mn(OH)₂, Mn₃O₄ or others. Any of these materials may be re-used as solid base materials for subsequent processing of slags or other feedstock materials as described herein. Similarly, any strong or weak acid (including HCl, alkali-bisulfate, ammonium bisulfate, sulfuric acid, carbonic acid, or any others), whether produced by an electrochemical acid-base generation system or otherwise, may be used in connection with the various aspects herein. In some aspects, commercially purchased, recycled, or otherwise obtained acid or base materials may be used in combination with acid and/or base materials produced with an electrochemical acid-base generation system.

Steel slag (from an EAF, BOF, or other) is in a molten state when leaving a steelmaking operation and is typically cooled for storage, transport, or subsequent use. Depending on the chemical composition of a slag and how quickly it is cooled, the crystal morphology of the final cooled solid slag may range from highly crystalline (e.g., very slowly cooled) to highly amorphous (e.g., following rapid cooling or quenching in water). In some cases, the rate and/or extent of slag dissolution in an acid may be a function of the acid(s) used and the degree of crystallinity or amorphousness of the slag (or other input material). Therefore, in some aspects, it may be desirable to select or selectively produce amorphous slag materials or crystalline slag materials for use in one or more of the aspects herein and/or to adjust slag production processes (e.g., cooling rates or quenching) to achieve a desired degree of crystallinity or amorphousness.

In some aspects, some materials extracted and isolated from a slag leach solution, including calcium hydroxide and/or magnesium hydroxide, may be used for capturing carbon dioxide either from a point source (such as an EAF or BOF steelmaking plant, a blast furnace, a CO₂-emitting direct-reduction iron (DRI) plant, a CO₂ emitting power plant, or directly from air. Alternatively or in addition, some materials, such as calcium oxide, calcium hydroxide, calcium carbonate, magnesium oxide, magnesium hydroxide, and/or magnesium carbonate may be used as flux again in a new steelmaking operation. In some aspects, iron oxides, hydroxides, sulfates, chlorides, or other iron compounds may be extracted from the slag leach solution and reduced or otherwise converted to metallic iron for steelmaking or other purposes. In some aspects, metallic iron may be extracted directly from the slag leach solution. In some aspects, one or more oxides or hydroxides of manganese (e.g., Mn₃O₄, Mn(OH)₂, MnO₂, or other oxides, hydroxides, or salts of Mn) may be extracted and used or sold for other products or processes. Other extracted materials, such as aluminum oxides, aluminum hydroxides, or aluminum phosphates may also be extracted and used or sold.

In some aspects, the acid and base solutions may be produced electrochemically in a salt-splitting acid-base generation (ABG) cell or cell-stack, some examples of which are shown and described in Applicant's PCT patent application #PCT/US2022/020796, titled “Carbon Capture Using Electrochemically-Produced Acid and Base,” published as WO2022197954A1, which is incorporated herein by reference in its entirety to the extent not inconsistent herewith. Other example acid-base generation cells are described in U.S. Pat. Nos. 4,561,945 5,595,641, 5,200,046, which are incorporated herein by reference in their entireties to the extent not inconsistent herewith. Any of the electrochemical acid-base generation cells shown and described in any of the above-referenced documents may be used to produce acid and base solutions for use in connection with any of the various aspects described herein. Alternatively, a conventional electrochemical chlor-alkali plant may be used to produce an aqueous alkali solution and chlorine gas. The chlorine gas may be combined with water at an elevated temperature (e.g., about 250° C.) to produce aqueous HCl. Using electrochemical methods, acid and base may be produced economically and with zero carbon emissions by one or more electrochemical systems powered by a zero-carbon electrical energy source such as wind power, solar power, geothermal power, hydropower, tidal/wave power, nuclear power, or other power source substantially free of carbon dioxide (CO₂) or other greenhouse gas emissions.

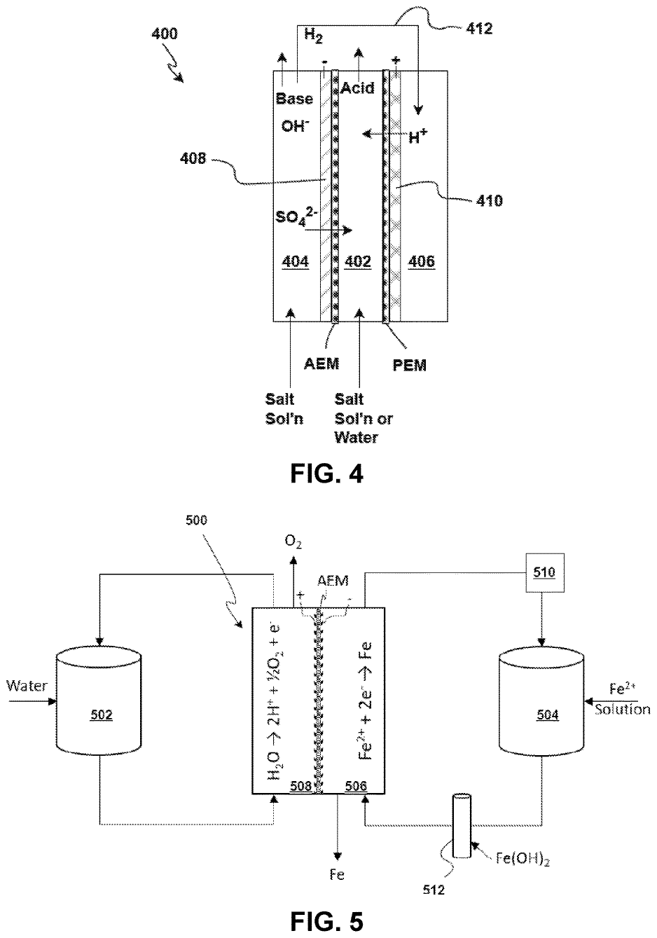

FIG. 4 illustrates an example electrolytic acid-base generation (“ABG”) cell 400. The cell 400 of FIG. 4 comprises a basifying chamber 404 (alternatively referred to as a “cathode chamber”) which contains an aqueous “cathode electrolyte” (or “catholyte”) and/or an aqueous “salt solution” in which a base concentration (i.e., a concentration of OH⁻ or hydroxide ions) increases during operation of the cell 400.

The cell 400 also comprises an acidifying chamber 402 (alternatively referred to as a “central” or “middle” chamber) which contains an aqueous “acidifying solution” or “acid solution” and/or an aqueous “salt solution” in which an aqueous acid concentration (i.e., a concentration of H⁺ or hydronium ions) increases during operation of the cell. The basifying chamber 404 is separated from the acidifying chamber 402 by an anion-exchange membrane (AEM).

The cell 400 also comprises an anode chamber 406 containing an anode electrode 410 (optionally a gas diffusion anode) separated from the acidifying chamber 402 by a proton exchange membrane or a cation exchange membrane (collectively referred to as a PEM).

During operation, while electrical current is supplied to the anode 410 and cathode 408 electrodes, water is reduced (or “split”) to form hydroxide ions (OH⁻) and hydrogen gas (H₂). The hydrogen gas is separated from the aqueous catholyte and transported to the anode chamber 406 via conduit 412. At the anode electrode 410, the hydrogen gas is oxidized to H⁺ (or hydronium) ions which are transported through the PEM separator membrane into the central acidifying chamber 402.

Anions from the basifying salt solution (shown as sulfate ions, SO₄⁻ in the illustrated example) migrate from the negative basifying chamber 404 to the central acidifying chamber 402 through the AEM separator membrane where they may combine with “free” protons (from the anode) to form a strong or weak acid.

In various aspects, the solution delivered into the central chamber 402 may be a substantially salt-free water solution, or a salt solution, which may be the same salt solution as that supplied to the basifying chamber 404 or a different salt solution.

The electrochemical potential between the H₂ generation reaction in alkaline conditions at the negative electrode vs the H₂ oxidation reaction in acidic condition at the positive electrode results in a theoretical cell potential of just 0.83V. In the illustrated example (assuming a salt of sodium sulfate), the theoretical energy requirement is 0.5 MWh per ton of NaOH produced, which is one third of the energy required to produce both base and acid solutions via a chlor-alkali process. While FIG. 4 and the above description are provided with reference to a sodium sulfate salt, the illustrated cell may be similarly operated with any other salt to produce other acid and base combinations.

In commercial-scale implementations, electrochemical acid base generation systems will typically include multiple electrochemical cells integrated into a common system. In some cases, those cells may be integrated in a single “bipolar stack” in which many cells are assembled in a single bread-loaf stack with individual cells separated from one another by electrically conductive “bipolar plates.” Cells within a bipolar stack are electrically connected to one another in series. Electrolytes typically flow through cells within a bipolar stack in fluidic parallel in a flow-through configuration. Although series flow configurations are also possible. In various configurations, multiple bipolar stacks may be connected to one another both electrically and fluidically in either parallel or series (or combinations of these). In alternative configurations, “monopolar” cells may be electrically and fluidically connected to one another in parallel. The relative benefits of bipolar vs monopolar configurations are well understood by those skilled in the art, and any such configuration approaches may be applied to aspects of electrochemical acid base generation systems described herein.

Regardless of whether an ABG is configured in a bipolar or monopolar format, the acid solution and base solution may each be circulated between the electrochemical reactor and respective storage tanks (e.g. one or more storage tank may be provided for each of the acid solution and the base solution). In some aspects, acid and/or base solutions may be directed to a chemical reactor such as a leach tank or an ion-exchange reactor to remove (or consume) acid and/or base from the solution(s) in order to limit the concentration of acid or base in the electrolyte(s) returning to the electrochemical reactor.

For example, in some aspects, an acid may be recirculated between an acid-base generation reactor and an acid storage tank such that an acid concentration of the acidifying electrolyte increases during each pass through the reactor. Such recirculation may continue until a target acid concentration (or pH) is achieved, at which point the acid solution may be used as described herein. The same may be done with the basifying solution. Alternatively or in addition, an acid solution may be recirculated between an acid-base generation reactor and a dissolution or leaching reactor in which some of the acid is consumed in a dissolution or leaching reaction after each cycle through the ABG reactor (or after every two cycles, or after every three cycles, etc.). For example, the acid may be consumed in any of the dissolution or leaching reactions described herein before returning all or a portion of the acidifying solution to the acidifying chamber of the ABG reactor. Alternatively, acid may be consumed in a base neutralization reaction, in a precipitation reaction, or by reaction with an ion-exchange resin. Examples of acid-consuming reactions herein include dissolving a slag or other feedstock material, dissolving a gypsum material, dissolving a precipitated iron product or other precipitated product. Similarly, the same can be done with the basifying solution to consume a portion of the base in an acid-neutralization reaction, a high pH leaching reaction, a precipitation reaction, or by reaction with an ion-exchange resin.

In various aspects, one or both of the acid solution and the base solution may comprise an aqueous solution including one or more dissolved salts. Some examples are described herein with reference to electrolytes containing dissolved sodium chloride salt, yielding sodium cations and chloride anions. Other salts may also be used alone or in combination. For example, in various aspects the acid solution and/or base solution may comprise anions and cations from any one salt or combination of salts, such as sodium chloride (NaCl), sodium sulfate (Na₂SO₄), sodium carbonate (Na₂CO₃), sodium nitrate (NaNO₃), sodium acetate (CH₃COONa), sodium citrate (Na₃C₆H₅O₇) sodium maleate (C₄H₃O₄Na), sodium oxalate (Na₂C₂O₄), potassium chloride (KCl), potassium sulfate (K₂SO₄), potassium carbonate (K₂CO₃), potassium nitrate (KNO₃), potassium acetate (CH₃COOK), potassium citrate (K₃C₆H₅O₇), potassium maleate (C₄H₃O₄K), potassium oxalate (K₂C₂O₄), lithium chloride (LiCl), lithium sulfate (Li₂SO₄), lithium nitrate (LiNO₃), lithium acetate (C₂H₃LiO₂), lithium oxalate (C₂Li₂O₄), one or more sodium, potassium, or lithium phosphates ([Na, K, or Li]_{X}H_{Y}PO₄(H₂O)_{z}) including hydrous and anhydrous forms of any di- or polysphosphate, or any other organic or inorganic salts or combinations of salts. In some aspects, the quantity of salt to be used may be selected based on a desired acid and/or base concentration to be produced.

TABLE 1
Salts and their corresponding acid and base

| Salt | Acid | Base |
|---|---|---|
| NaCl | HCl (hydrochloric) | NaOH |
| Na₂SO₄ | H₂SO₄ (sulfuric) | NaOH |
| Na₂SO₄ | NaHSO₄ (sodium bisulfate) | NaOH |
| Na₂CO₃ | H₂CO₃ (carbonic) | NaOH |
| NaNO₃ | HNO₃ (nitric) | NaOH |
| CH₃COONa | C₂H₄O₂ (acetic) | NaOH |
| Na₃C₆H₅O₇ | C₆H₈O₇ (citric) | NaOH |
| C₄H₃O₄Na | C₄H₄O₄ (maleic) | NaOH |
| Na₂C₂O₄ | C₂H₂O₄ (oxalic) | NaOH |
| Sodium Phosphate | H₃PO₄ (phosphoric) | NaOH |
| KCl | HCl (hydrochloric) | KOH |
| K₂SO₄ | H₂SO₄ (sulfuric) | KOH |
| K₂SO₄ | KHSO₄ (potassium bisulfate) | KOH |
| K₂CO₃ | H₂CO₃ (carbonic) | KOH |
| KNO₃ | HNO₃ (nitric) | KOH |
| CH₃COOK | C₂H₄O₂ (acetic) | KOH |
| K₃C₆H₅O₇ | C₆H₈O₇ (citric) | KOH |
| C₄H₃O₄K | C₄H₄O₄ (maleic) | KOH |
| K₂C₂O₄ | C₂H₂O₄ (oxalic) | KOH |
| Potassium Phosphate | H₃PO₄ (phosphoric) | KOH |
| LiCl | HCl (hydrochloric) | LiOH |
| Li₂SO₄ | H₂SO₄ (sulfuric) | LiOH |
| Li₂SO₄ | LiHSO₄ (lithium bisulfate) | LiOH |
| Li₂CO₃ | H₂CO₃ (carbonic) | LiOH |
| LiNO₃ | HNO₃ (nitric) | LiOH |
| C₂H₃LiO₂ | C₂H₄O₂ (acetic) | LiOH |
| Li₃C₆H₅O₇ | C₆H₈O₇ (citric) | LiOH |
| C₄H₃O₄Li | C₄H₄O₄ (maleic) | LiOH |
| C₂Li₂O₄ | C₂H₂O₄ (oxalic) | LiOH |
| Lithium Phosphate | H₃PO₄ (phosphoric) | LiOH |
| (NH₄)₂SO₄ | (NH₄)HSO₄ (ammonium bisulfate) | NH₄OH |

In some aspects, an electrolytic or electrodialytic acid-base generator may be configured to produce an aqueous bisulfate (HSO₄) compound by splitting a sulfate salt such as sodium sulfate, potassium sulfate, lithium sulfate, ammonium sulfate, and/or others without proceeding to form sulfuric acid (H₂SO₄). The produced sodium bisulfate and/or ammonium bisulfate may be used to dissolve (or “leach”) the slag or other feedstock material as described in various aspects herein.

In some aspects, an acid-base generator may be configured and/or operated to produce predominantly a bisulfate solution in an acidifying chamber rather than sulfuric acid by supplying the central (acidifying) chamber of a cell such as that shown in FIG. 4 with a salt solution with an initial cation (e.g., Na⁺, K⁺, Li⁺, NH₄⁺, etc.) concentration equal to the target or intended concentration of bisulfate.

In various aspects, an aqueous bisulfate solution may be produced in an electrochemical acid base generation cell 400 such as that shown in FIG. 4. As protons produced by the oxidation of hydrogen gas cross into the central chamber 402, they will tend to pair with the sulfate anions (SO₄²⁻) and the salt cations in the acidifying salt solution to form bisulfate with the metal cation (e.g., NaHSO₄). Once all of the salt cations are paired with protons and sulfate anions, in the absence of further metal cations, further addition of protons and sulfate anions to the acidifying chamber will tend to form sulfuric acid (H₂SO₄).

Therefore, in a batch process, in order to stop acid production at bisulfate before proceeding to production of sulfuric acid, the current delivered to the cell 400 should be stopped when the total charge (or quantity of coulombs=current*time) delivered to the cell equals the stoichiometric quantity equivalent to the total mole quantity of the metal cation present in the salt solution delivered to the central chamber. In some aspects, a concentration of salt to be delivered to the acidifying chamber may be measured at the start of a batch process to determine the electrical current and/or duration of the next batch of bisulfate production.

In a continuous bisulfate production process, the acidifying chamber may continue to produce bisulfate as long as the salt solution (which may contain a concentration of bisulfate from a previous cycle) delivered into the acidifying chamber contains at least a minimum concentration of the chosen cation (e.g., Na⁺ or NH₄⁺).

In some aspects, production of acid and base by an electrolytic acid-base generator may be further improved by producing a weak acid rather than a strong acid. Weak acids are defined as those acids that do not fully ionize when dissolved in water. Because weak acids more tightly bond protons (i.e., they are “weak” in that they are less prone to giving up protons), those protons bound in the weak acid are less likely to migrate across any separator membrane into a chamber containing hydroxyl ions and causing inefficiency by recombining to form water.

In various aspects, any of the acid-base generator cell configurations described herein may be used to produce weak acids by selecting a salt prone to weak-acid production once split into component acid and base. Examples of common salts leading to weak acids include Na₂CO₃ or NaHCO₃ (e.g., to make carbonic acid), NaH₂PO₄ (e.g., to make phosphoric acid), CH₃CO₂Na (e.g., to make acetic acid), a salt of oxalic acid (C₂H₂O₄), a salt of citric acid (C₆H₈O₇), a salt of maleic acid (C₄H₄O₄), and a salt of boric acid (H₃BO₃).

Other salts yielding weak-acids when split, including some organic salts, may be used in an acid-base generator to produce a weak acid rather than a strong acid to thereby improve the coulombic efficiency of the acid-base generator. In some aspects, any combination of salts can be employed, including combinations of salts in this paragraph or combinations of one or more salts of this paragraph with any other salt or salts disclosed elsewhere herein.

In various aspects, an acid solution and/or a base solution may have a salt concentration (i.e., a concentration of anions and cations corresponding to a dissolved salt) of about 0.1 M to about 5 M, or in some aspects up to the saturation limit for the given salt (e.g., NaCl has a room-temperature solubility limit of about 6.2 M). In other aspects, salt concentrations for an acid solution and/or a base solution may be selected based on a concentration ratio sufficient to encourage cross-separator transfer of a preferred ion (cation or anion) in favor of a more ionically-mobile ion as described in PCT/US22/20796 referenced above.

In various aspects, described below, the salt(s) split in an electrochemical acid regeneration cell may be recovered and recycled to make new acid and base solutions after extracting reusable materials from a slag. Therefore, systems described herein may be configured to consume substantially only electricity and water (some of which may be recovered as described herein), and to minimize the consumption or loss of any chemical reactants.

### Refining and Recycling Metallurgical Slags

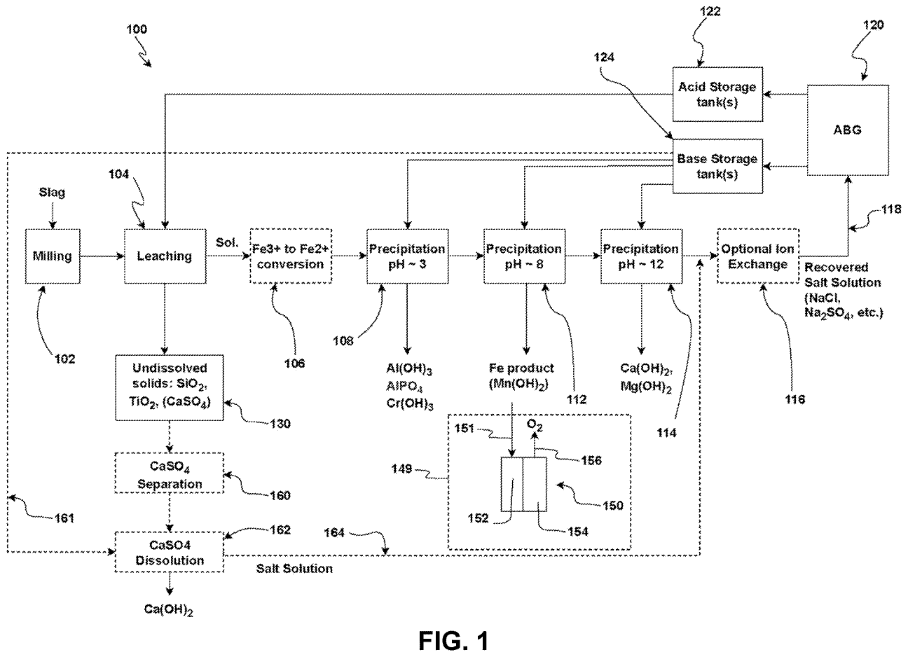

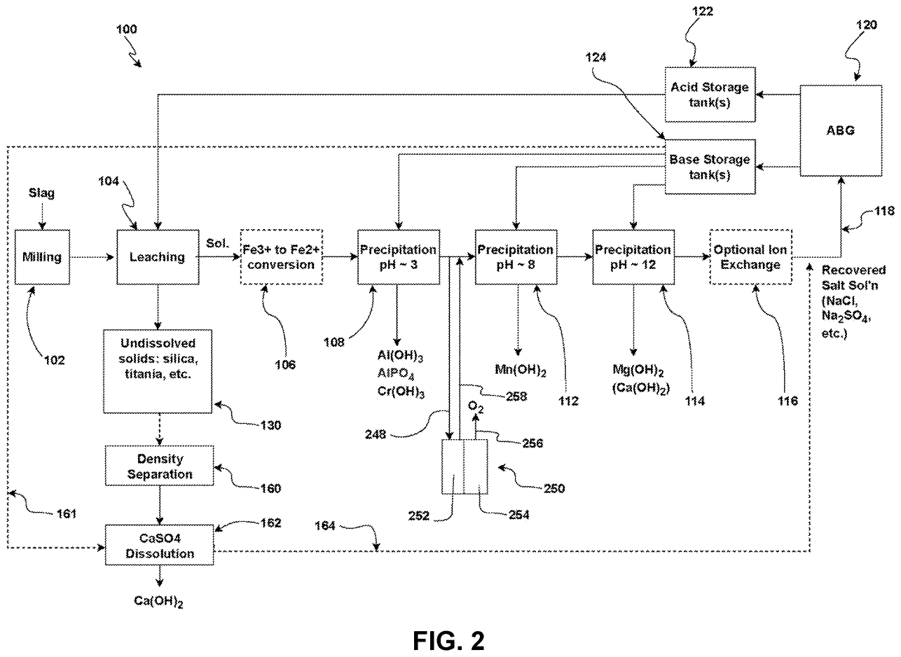

In various aspects, examples of which are described below with reference to FIG. 1 and FIG. 2, slag and/or other input material(s) may be dissolved/leached in an aqueous acid to produce a slag leach solution, and various components may be extracted from the slag leach solution by selective precipitation following a pH shift induced by addition of an aqueous base solution and/or a solid soluble base material to the slag leach solution. Alternatively, components may be selectively removed from the leach solution by other processes such as electrowinning (also referred to herein as electroplating), recrystallization, cementation, and/or other methods.

In various aspects, the processes of FIG. 1 and FIG. 2 may be operated with the acid, base, and/or leach solution at an elevated temperature relative to ambient temperature. For example, in some aspects, at least the leaching steps and precipitation steps (inclusive of solid/liquid separation steps for removing products) may be performed with the aqueous solutions at a temperature of between about 50° C. and about 90° C., in some more specific aspects, between about 60° C. and about 80° C., and in some specific aspects at about 60° C.+/−5° C., at about 70° C.+/−5° C., or at about 80° C.+/−5° C. In some aspects different steps may be performed at different temperatures relative to other steps, some examples of which are described below.

Some aspects of processes for extracting re-usable materials from metallurgical slag will now be described with reference to the schematic block diagram of FIG. 1. In some aspects, a process 100 for extracting components of metallurgical slag may comprise utilizing an electrochemical acid-base generator (ABG) 120 to produce an acid solution which may be stored in one or more acid storage tanks 122, and a base solution which may be stored in one or more base storage tanks 124. By storing acid and base in respective storage vessels, the production of the solutions may be decoupled in time from their use in subsequent processing. This may allow for the acid and base production to proceed at different times and at different rates relative to the material dissolution and precipitation processes.

At block 102, a slag material may be milled into smaller particles, if needed. Milling may comprise ball-milling, grinding, crushing, pulverizing, or any similar processes or equipment for transforming rock-sized pieces into smaller particles suitable for acid leaching. In various aspects, slag may be milled into particles less than about 10 mm in average or maximum size.

In some aspects, an optional magnetic separation step may be performed after milling. The slag may contain some magnetic material(s), which will tend to be predominantly iron-containing oxides such as magnetite (Fe₃O₄) and iron metal. The separated magnetic material may be removed and processed into iron or steel. For example, the separated magnetic material may be thermally reduced to metallic iron in a direct-reduction of iron (DRI) or blast furnace process, or the magnetic material may be dissolved in a separate acid and electrodeposited as metallic iron.

In some aspects, the slag material may be treated prior to magnetic separation in order to convert any non-magnetic iron into a magnetic form of iron. For example, the slag (before or after milling), may be heated in a reducing atmosphere (e.g., hydrogen gas, carbon monoxide, syn-gas, etc.) to reduce non-magnetic iron oxides (e.g., Fe₂O₃) to a magnetic form such as magnetite (Fe₃O₄) or even to metallic iron. In such cases, substantially all of the iron present in the slag may be separated and removed from the slag by magnetic separation, meaning steps 106 and/or 112 of FIG. 1 may be omitted.

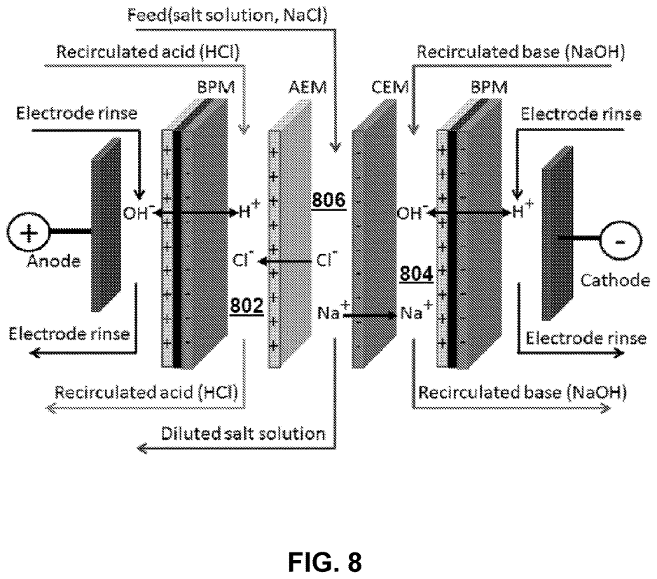

In some aspects, it may be advantageous to concentrate an acid produced by an acid-base generator prior to using it for leaching a slag or other feedstock material. In some cases, acid exiting an acid storage tank 122 may be concentrated by removing water via a distillation or evaporation process such as multiple-effect evaporation, mechanical vapor recompression, steam distillation, vacuum distillation, membrane distillation, reverse osmosis, or combinations of these and/or other processes. In various aspects, any heat required for these or other distillation methods may be provided by waste heat generated by other parts of this process or by an adjacent steel mill or other plant. In other aspects, the acid solution may be concentrated using an electrodialytic cell such as that shown and described in FIG. 8 or differently configured electrodialytic cells utilizing bipolar membranes.

At block 104, the milled slag material may be mixed with a portion of the acid solution from the acid storage tank(s) 122 to dissolve components of the slag, thereby producing an aqueous leach solution containing dissolved components of the slag. Any components of the slag that do not dissolve in the acid solution may be separated and removed at block 130 by filtering, flocculation, centrifuge, settling, or any other suitable solid/liquid separation technique or combination of techniques. The undissolved solids 130 may be discarded as waste or subjected to further treatment to extract components for subsequent sale or use. In some aspects, the undissolved solids 130 may be separated in the form of an acidic slurry which may be washed with a portion of the base solution in order to neutralize any remaining acid.

Optional blocks 160 and 162 are provided to illustrate optional or alternative steps useful in cases in which the acid solution contains a sulfate anion. In such cases, any calcium in the feedstock material (e.g., slag) will tend to immediately precipitate as calcium sulfate (CaSO₄) almost as quickly as it dissolves because CaSO₄ has a low aqueous solubility limit. Therefore, in aspects in which sulfate salts are used, the CaSO₄ may be collected along with other “undissolved” solids at 130. The CaSO₄ may then be separated 160 from other undissolved solids (primarily silica) by any suitable solid/solid separation technique such as density separation, high shear mixing, centrifugation, flotation, etc. The separated CaSO₄ may then be converted to a hydroxide compound at 162 using a portion of the base solution via 161 (and/or a separate base solution) from which calcium hydroxide (Ca(OH)₂) may be precipitated by adding sufficient base to reach a pH at which the Ca(OH)₂ will precipitate (e.g., at a pH of about 12). The remaining solution, which will tend to be a salt solution containing the sulfate and base cations, may be returned via 164 to the ABG 120 for subsequent splitting into new acid and base solutions. Optionally, the remaining solution following Ca(OH)₂ precipitation may be treated in an ion exchange resin at 116 to remove any residual dissolved calcium or magnesium.

In various aspects, the leaching/dissolution step 104 may be performed in a dissolution vessel or tank (e.g., a continuously stirred tank reactor) or other container. Alternatively, the leaching/dissolution step 104 may be performed in a heap-leach operation in which acid is sprayed over a pile (or heap) of slag, and the leachate is collected from the bottom.

In various aspects, the choice of acid (and therefore salt) to be used for slag dissolution may be made based on which components of the slag are sought, because some components may dissolve more readily or completely depending on thermodynamic solubility limit of each component and its dissolution kinetics in a given acid.

Following or during acid leaching 104, the leach solution may be treated to reduce any ferric iron ions (Fe³⁺) to ferrous iron ions (Fe²⁺) in order to facilitate subsequent separation of iron independent of other major slag components (as described in further detail below). In various aspects, reduction of ferric iron ions to ferrous iron ions may be performed electrochemically in one or more electrochemical cells, or chemically in a suitable reactor. For example, Fe³⁺ ions may be chemically reduced to ferrous ions by sparging or bubbling a reducing gas (e.g., carbon monoxide or hydrogen gas) through the aqueous solution, optionally at an elevated temperature, optionally in the presence of a catalyst. In other example aspects, Fe³⁺ ions may be reduced to Fe²⁺ ions by dissolving metallic iron in the leach solution. The metallic iron will react with the Fe³⁺ ions to produce Fe²⁺ ions. Any source of metallic iron may be used, including scrap iron, scrap steel, busheling steel, electrolytic iron, iron dust or steel dust (i.e., typical waste materials produced in ironmaking and steelmaking processes), or others. Alternatively, the ferric reduction step of step 106 may be omitted entirely, and any ferric iron may be precipitated separately from ferrous iron (as described below).

In some aspects, acid leaching 104 and conversion of Fe³⁺ (ferric iron) to Fe²⁺ (ferrous iron) may be coupled to one another via an “acid regeneration” cell as described in Applicant's PCT patent application PCT/US2022/021729 titled “Ore Dissolution and Iron Conversion System” published as WO2022204391A1, which is incorporated herein by reference in its entirety to the extent not inconsistent herewith (hereafter, the “Iron Conversion” application). As described in the Iron Conversion application, an electrochemical acid regeneration cell may be configured with an anode separated from a cathode by a cation exchange membrane (also known as a proton exchange membrane or PEM). If the acid solution is predominantly sulfuric acid (H₂SO₄), such an acid regeneration cell may be configured to anodically oxidize water and evolve oxygen from an anode electrolyte while cathodically reducing dissolved ferric (Fe³⁺) iron ions to ferrous iron (Fe²⁺) in the cathode electrolyte solution. regenerator anode. Therefore, in some aspects it may be preferable to use pure water (e.g., deionized water) or a different acid (e.g., sulfuric, acetic, etc.) as an anode electrolyte in an acid regeneration cell. Alternatively, if an economical source of hydrogen gas is available, the acid regenerator anode may be configured to oxidize hydrogen gas at the anode.

The anodic water splitting reaction (or chlorine gas evolution or hydrogen gas oxidation) will also liberate protons which will tend to cross the cation exchange membrane into the cathode electrolyte, thereby increasing acidity (decreasing pH) of the cathode electrolyte. By recirculating cathode electrolyte between the acid regeneration cell cathode and a vessel in which leaching/dissolution is performed, some of the acid (H⁺) consumed during dissolution may be regenerated in the electrochemical acid regeneration cell, thereby enabling faster or more complete dissolution of the slag material.

After leaching 104 and ferric reduction 106 (if performed) is complete, the leach solution may be transferred to a first precipitation step 108 during which a base from the base storage tank 124 (or other liquid or solid source) may be mixed with the leach solution in a precipitation vessel (e.g., a settling tank or other suitable solid/liquid separation vessel).

In various aspects, the base used to raise pH in any of the precipitation steps may be (or may be supplemented with) solid base materials produced in previous cycles of this process or other processes. Such solid base materials may include Ca(OH)₂, Mg(OH)₂, Al(OH)₃, Fe(OH)₂, Fe(OH)₃, or others.

In various aspects, removal of products following some or each of the precipitation steps may be assisted by additional solid/liquid separation techniques. For example, any combination of techniques may be used to assist separation of one or more products from the leach solution or from other products. Such techniques may include, but are not limited to, filtration, shear mixing, gravity separation, settling, centrifugation, sedimentation, cementation, flocculation, crystallization, or evaporation.

Base may be added during the first precipitation step 108 to raise the leach solution pH to a level at which a first product begins to precipitate, e.g. a pH of about 3 to 4. Base addition may continue (optionally at a slow rate or in discrete quantities) until a first product is fully precipitated. In some aspects, the base added during the first precipitation step may be an aqueous base solution from an acid-base generation system.

In some aspects, a first product collected from the first precipitation step 108 may comprise, consist of, or consist essentially of aluminum hydroxide (Al(OH)₃). In other aspects, the first product may also comprise some ferric iron (III) hydroxide (Fe(OH)₃) if the leach solution contains a measurable amount of Fe³⁺ ions (e.g., if the ferric reduction step 106 is omitted, reduces less than 100% of ferric ions in solution, and/or if some ferrous ions are oxidized to ferric).

In some aspects, the product of the first precipitation 108 may comprise a mineral containing aluminum among other elements, such as an alunite (potassium aluminum sulfates, e.g. KAI₃(SO₄)₂(OH)₆) and/or a natroalunite (sodium aluminum sulfates, e.g. NaAl₃(SO₄)₂(OH)₆). In such aspects, the alunite and/or natroalunite may be physically separated from other precipitated materials, re-dissolved in an aqueous acid or base solution (e.g., the base solution produced by an ABG), and then products such as Al(OH)₃ and/or Fe(OH)₃ may be precipitated from the second solution.

The inventors have found that, when using a sulfate acid (sulfuric or a bisulfate), filtration of the first product may be improved by using calcium hydroxide (Ca(OH)₂) as the base driving the pH shift for the first precipitation 108. This is partly due to the immediate formation of gypsum (calcium sulfate, CaSO₄) as a fine particulate which acts as a filtration medium through which the first product may be filtered. Following the first precipitation, the first product may be separated from the gypsum filter cake by gravity separation, flotation, density separation, or other suitable separation technique.

In some aspects, a first product may also comprise silica which may be flocculated by the first precipitated product. For this reason, in some aspects, some amount of ferric iron (Fe³⁺) may be left in solution and ferric hydroxide may be precipitated at a pH of about 2 to 3 before precipitating a separate aluminum hydroxide product.

If present in the slag, other materials that precipitate at a pH greater than about 3 may be included with the first product if desired. For example, titanium hydroxide (Ti(OH)₄) will precipitate at a pH of about 2 to 3, and may therefore be included with the first product, or may be precipitated as a separate product. Similarly, any other materials present in the slag that tend to precipitate at a pH between about 3 and about pH 8 may be precipitated and included with either the product of the first precipitation 108 or the product of the second precipitation 112.

In some aspects, a second precipitation step 112 may be performed in a separate precipitation vessel or the same precipitation vessel as the first precipitation 108. In various aspects, a product collected from the second precipitation step 112 may comprise, consist of, or consist essentially of ferrous iron (II) hydroxide (Fe(OH)₂) which will tend to precipitate at a pH of about 7 to 8. Optionally, as described elsewhere herein, the second product may also comprise manganese hydroxide (Mn(OH)₂) or other materials.

In some aspects, an iron-containing product may alternatively be produced by recrystallization. For example, in some aspects, before or after the first precipitation step 108, the solution containing dissolved iron may be heated to an elevated temperature (e.g., during the initial dissolution or at a later time) and additional ferrous iron may be added to the solution to super-saturate it with ferrous iron. The elevated temperature may be about 50° C. to about 80° C. or about 60° C. in some aspects. The solution may then be cooled to ambient temperature or lower, causing the iron salt (e.g., ferrous sulfate, ferrous chloride, etc. depending on the acid used) to recrystallize to a solid. The ferrous salt crystals may then be separated from the solution.

In some aspects, any iron-containing product precipitated from the leach solution may be sent to an optional electroplating plant 149 as shown in FIG. 1. For example, precipitated ferrous hydroxide may be re-dissolved at 151 to form an aqueous solution rich in Fe²⁺ from which metallic iron may optionally be electroplated in an electroplating cell 150. The electroplating cell 150 may be a plating cell such as those described in the above-referenced Iron Conversion Application, or cells such as those described below with reference to FIG. 2 and FIG. 5.

In some aspects, the first and/or second product may comprise, consist of, or consist essentially of magnetite (Fe₃O₄). Magnetite may be preferentially precipitated by ensuring the proper ratio of Fe³⁺ and Fe²⁺ in the aqueous leach solution: a 2:1 ratio of Fe³⁺ to Fe²⁺. With the solution at a pH of about 3 (e.g., immediately before or after the first precipitation step 108), a portion of the ferric iron present in the solution may be oxidized to ferric by adding a liquid oxidant such as hydrogen peroxide, or by contacting the leach solution with a gaseous oxidant such as air, ozone, or others until the desired quantity of Fe³⁺ is produced. In aspects in which magnetite is to be precipitated, the optional reduction step 106 may be omitted. In various aspects, magnetite precipitation may be performed at a temperature of between about 50° C. and about 80° C., and in some aspects at about 60° C.

Once the desired ratio of ferric-to-ferrous ions is achieved, base may be added to the solution (in some aspects, slowly over a period of several hours up to 24 hours) to raise the pH to about 8 or until a magnetite product precipitates.

Once magnetite is precipitated, it may be separated from the leach solution (e.g., by filtration). Magnetite (being magnetic) may be magnetically separated from any other constituents of the second precipitation product such as manganese-containing products or compounds such as Mn(OH)₂ and/or Mn₃O₄. The magnetite and/or Mn-containing product may then be optionally separated, collected, optionally calcined and sold or used directly. In some aspects, a separated product consisting essentially of magnetite may be transferred to a two-step iron conversion system such as that described in the above-referenced Iron Conversion Application for electroplating of a metallic iron product.

In still other aspects, as described below with reference to FIG. 2, all or a substantial portion of dissolved iron may be removed (e.g., by electroplating or by recrystallization as described above) prior to the second precipitation 108, leaving substantially only manganese compounds such as Mn(OH)₂ and/or Mn₃O₄ to be removed as a product of the second precipitation.

In some aspects, a third precipitation step 114 may be performed in the same or a different precipitation vessel. In the third precipitation step, base may be added until a third product is fully precipitated. As shown in FIG. 1, the third product may comprise, consist of, or consist essentially of calcium and/or magnesium hydroxide (Ca(OH)₂ and/or Mg(OH)₂) or other compounds comprising, consisting of, or consisting essentially of magnesium and/or calcium. For example, if sulfate chemistry is used, very little calcium may remain in solution prior to the third precipitation step 114, and therefore in such cases, the third product may consist essentially of magnesium compounds with very little (if any) calcium. If a different acid salt is used (e.g., HCl), then a third precipitation may comprise two parts: a first part yielding Mg(OH)₂ at a pH between about 10 and about 12, and a second part yielding Ca(OH)₂ at a pH above 12. In other aspects, a product may comprise, consist of, or consist essentially of both magnesium and calcium compounds. In some aspects, shear mixing may be used to assist with separation of a Mg(OH)₂ product.

After the third precipitation 114, the solution will tend to contain substantially only the salt(s) from mixing the acid and base solutions. However, some un-precipitated ions may remain. So, in some aspects, the leach solution exiting the third precipitation 114 may optionally be treated with an ion exchange resin in order to remove any remaining ions that may interfere with operation of the electrochemical acid-base generator. For example, any remaining calcium or magnesium may be harmful to separator membranes in the ABG cells, and should therefore be removed prior to returning the salt solution to the electrochemical acid-base generator via conduit 118. If needed, after the final precipitation step, additional base may be added to the remaining leach solution in order to neutralize the pH and equalize the salt solution. If needed, any of the precipitated products may be washed with water or a portion of the base solution to dilute or neutralize any remaining acid.

In some aspects, each major component described above may be precipitated separately. Therefore, while only three precipitation “steps” are illustrated in FIG. 1, in various aspects any number of precipitation steps may be used to separate various products, including mixtures of products. For example, using sulfuric acid, ferric hydroxide (Fe(OH)₃) may be precipitated first at a pH between 2±0.5 to 3±0.5, followed by aluminum hydroxide (Al(OH)₃) at a pH between 3±0.5 to 5±0.5, then ferrous hydroxide (Fe(OH)₂) at a pH between 7±0.5 to 8±0.5, then magnesium hydroxide (Mg(OH)₂) at a pH between 8±0.5 to 10±0.5, and then calcium hydroxide (Ca(OH)₂) at a pH between 10±0.5 to 12±0.5. Similarly, any other dissolved components may be precipitated separately or along with another component. In various aspects, any one precipitated product may contain material of more than one component, since some components may have slightly overlapping or closely adjacent solubility limits (pH ranges) at which precipitation occurs. Additionally, the need to separate different products may also depend on the intended application(s) and desired purity of the product materials. For example, in some applications, there may be no need to separate Ca from Mg and hence, the two hydroxide compounds may be precipitated together in a single step.

In some aspects, a slag recycling system may comprise two or more electrochemical acid-base generation systems configured to split different salts or salt mixtures so as to produce different acid and base solutions enabling more effective extraction of components that have different solubility limits in different acid or base solutions.

As will be understood by those skilled in the art, metal hydroxides are generally a hydrated form of a corresponding metal oxide. Therefore, in various aspects, any of the hydroxides described above may be dehydrated to remove excess water and convert the material to its corresponding oxide. Dehydration may typically be performed by heating the hydroxide material and allowing water to be released as water vapor. In some aspects, the water vapor may be captured and returned to the ABG for re-use. For example calcium hydroxide (Ca(OH)₂) may be dehydrated to form CaO according to:

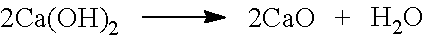

Similarly, magnesium hydroxide, iron hydroxides, and aluminum hydroxide may be converted to corresponding oxides prior to re-use, sale, or other disposition. In some aspects, waste heat from a high-temperature plant (e.g., a steelmaking plant, a power plant, an ironmaking plant, or others) may be used to dehydrate one or more of the hydroxides.

In some aspects, a precipitated iron product may be re-dissolved at 151 in a separate aqueous solution and electrochemically reduced to metallic iron in an iron electroplating cell 150 as shown in FIG. 1 (and/or using an electroplating cell of a configuration as shown and described with reference to FIG. 2 or FIG. 5). Precipitated ferrous hydroxide (Fe(OH)₂) and/or ferrous oxide (FeO) may be dissolved into an aqueous solution and directed into a cathode chamber 152 of the plating cell 150 (in some aspects by flowing the plating catholyte through a bed of solid Fe(OH)₂). Metallic iron may then be electroplated onto a cathode electrode, and the metallic iron may be removed for use as described herein. In some aspects, the reaction in the anode chamber 154 of the plating cell 150 may comprise evolution of oxygen 156 or chlorine (not show). In some aspects, the plating cell's anode electrode may be separated from the plating cell's cathode electrode by an anion exchange membrane (AEM). Alternatively, the plating cell's anode electrode may be separated from the plating cell's cathode electrode by an proton exchange membrane (PEM).

FIG. 2 illustrates alternative aspects of the process described above with reference to FIG. 1. Steps and structures common to both aspects are numbered consistent with the above description of FIG. 1. The aspects of FIG. 2 introduce an alternative method of removing iron by directly electroplating iron from the leach solution.

In some aspects, as illustrated in FIG. 2, dissolved iron in the leach solution may be removed by electroplating metallic iron onto a cathode electrode in a plating cell 250 (also referred to as electrowinning, electrodeposition, electroplating, electrolytic deposition, or similar terms). In some aspects, after a first precipitation 108, all or a portion of the leach solution may be directed via 248 to a cathode chamber 252 of an electroplating cell 250 in which iron may be electroplated from the leach solution. In the context of the electroplating cell, the leach solution may be referred to as a plating cell cathode electrolyte or “plating catholyte.”

In some aspects, plating catholyte may be recirculated between the electroplating cell and a plating catholyte storage tank (not shown) in a manner similar to that shown and described in the above-referenced Iron Conversion Application with reference to the “plating cell” therein and in FIG. 5 below. In some aspects, once the concentration of dissolved iron in the plating catholyte is depleted to a desired low-end iron concentration, it may be referred to as “spent” plating catholyte.

In some aspects, the spent plating catholyte may be concentrated, such as by removing water via one or more distillation or evaporation techniques such as those described herein. In various aspects, the low-end iron concentration identifying “spent” plating catholyte may be between about 0.2 M and 1 M.

Spent plating catholyte may be concentrated by removing water via a distillation or evaporation process such as multiple-effect evaporation, mechanical vapor recompression, steam distillation, vacuum distillation, membrane distillation, reverse osmosis, or combinations of these and/or other processes. In various aspects, any heat required for these or other distillation processes may be provided by waste heat generated by other parts of this process or by an adjacent steel mill or other plant.

In other aspects, iron remaining in a “spent” plating catholyte may be removed by recrystallization as described herein above.

In various aspects, electroplating in the plating cell 250 may occur while other non-iron ions are present in the leach solution (plating catholyte). Such non-iron ions may include ions of calcium, magnesium, manganese, and/or other elements or compounds. For example, in various aspects, during electroplating of iron, the leach solution (plating catholyte) may contain a concentration of between about 0.01 M and about 1 M of any combination of ions of Mg and Mn. If a non-sulfate acid is used, the plating catholyte may also contain between about 0.01 M and 1 M Ca ions.

In some aspects, the anode chamber 254 of the electroplating cell 250 may contain a plating cell anode electrolyte or “plating anolyte,” which may comprise an aqueous electrolyte such as sulfuric acid, deionized water, ferrous sulfate, or other aqueous solution. In some aspects, the anodic reaction of the plating cell 250 may be oxygen evolution 256 by splitting water in the aqueous anolyte. The water splitting reaction will also produce protons which will acidify the plating anolyte.

Alternatively, if a chloride salt is used, the anodic reaction may comprise chlorine gas evolution. In such aspects, the chlorine may be captured and dissolved in water to produce acid (H⁺ or hydronium ions).

In some aspects, a quantity of ferrous hydroxide (Fe(OH)₂) may be dissolved in the plating catholyte to consume any acid (H⁺ or hydronium ions) that may cross over the separator membrane (e.g., an AEM or PEM) from the anode to the cathode. Any such protons or acid reaching the plating cell cathode may cause a parasitic hydrogen evolution reaction, amounting to an inefficiency as electrical current would be consumed producing hydrogen instead of metallic iron.

In some aspects, all or a portion of spent plating catholyte may be directed to the anode chamber 254 of the electroplating cell 250. Under the oxidative conditions of the anode electrode, any Mn ions in the leach solution may tend to be oxidized to MnO₂ which will tend to precipitate in the anode chamber 254. Such precipitated MnO₂ may be collected as a manganese-containing product.

In various aspects, once electroplating is deemed complete, the remaining electrolyte, which may contain ions of Ca, Mn, Mg, etc., may be returned to a precipitation reactor 112 and/or 114 for precipitation and removal of remaining constituents as described herein. For example, Mn compounds may be removed as Mn(OH)₂ by adding base (e.g., a base from an acid base generator or a different base such as Mg(OH)₂ or Ca(OH)₂). Alternatively, Mn compounds may be removed as Mn₃O₄ by precipitation at a pH of around 8 by oxidizing a portion of the dissolved Mn to the Mn³⁺ ionic state by contact with a liquid or gaseous oxidant to produce a 2:1 ratio of Mn³⁺ to Mn²⁺ as described herein with reference to precipitation of magnetite (Fe₃O₄). In some aspects, magnesium hydroxide (Mg(OH)₂) may be used as the base to shift the solution pH to a range at which the Mn compound(s) precipitate. Such Mg(OH)₂ may be collected from a previous cycle of the process, or may come from an external source.

FIG. 5 illustrates an example iron electroplating system (also referred to as a “plating cell” or “electrodeposition cell”). As shown, an aqueous anolyte such as water or other aqueous solution (e.g., sulfuric acid, ferric sulfate, or others) may be recirculated between an anolyte storage tank 502 and an anode chamber 508 of an electroplating cell 500. The anodic reaction in the anode half-cell may be oxygen evolution according to:

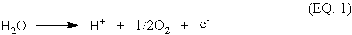

The cathodic reaction in the cathode half-cell may be reduction of ferrous iron to metallic iron according to:

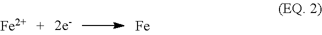

The anode chamber 508 is separated from the cathode chamber 506 by an anion exchange membrane (although PEM or microporous separators may be used in some alternative aspects).

As water is consumed in the anodic reaction of EQ1, supplemental make-up water may be supplied to the anolyte storage tank 502 or directly to the anode chamber 508 of the plating cell 500.

Metallic iron may be removed from the cathode chamber as plates, powder, or other form-factors by any methods such as those described in the Iron Conversion application referenced herein above.

The anode material of an iron electroplating cell, such as of the plating cell of FIG. 5, optionally has a composition comprising a carbon material, a graphite material, a mixed metal oxide, or any combination of these. The cathode material of an iron electroplating cell, such as of the plating cell of FIG. 5, optionally has a composition comprising a steel, low carbon steel, stainless steel, copper, copper alloy, or any combination of these. Additional components typical of an electrochemical cell or stack may include current collectors, bipolar plates, flow channels, end plates, etc., depending on a chosen plating cell configuration.

The H⁺ ions produced by the anodic reaction of EQ. 1 will tend to progressively acidify the anolyte solution. As the concentration of acid rises in the anolyte, the possibility of protons (or hydronium ions) crossing over the separator into the catholyte increases. Increasing acid concentration of the catholyte can decrease efficiency of the electroplating reaction by causing parasitic hydrogen evolution at the cathode and/or by re-dissolving plated iron.

Therefore, it is desirable to consume excess acid present in the plating catholyte. In some aspects, this may be accomplished by contacting the plating catholyte with a quantity of ferrous hydroxide (Fe(OH)₂) in a reactor 512. The reactor 512 may be any suitable reactor or vessel for contacting the electrolyte with ferrous hydroxide, such as a fluidized bed reactor or others. While the reactor 512 is shown between the catholyte tank 504 and the cell 500, the reactor 512 could alternatively be positioned between the cell 500 and the catholyte tank 504, within the cathode chamber itself 506 or at any other point in the catholyte flow path. In various aspects, the ferrous hydroxide in the reactor 512 may be obtained from a process such as those described herein, or from other sources.

As dissolved iron is electroplated at the cathode (indicated by the “-” sign), the concentration of Fe²⁺ ions in the catholyte will decrease, eventually starving the electroplating reaction of reactant, thereby increasing the occurrence of parasitic side reactions such as hydrogen evolution. Therefore, it is desirable to maintain a concentration of ferrous ions in the catholyte. In some aspects, this may be achieved by removing water from the catholyte in a concentration reactor 510.

In some aspects, water may be removed via the concentration reactor during each cycle of catholyte through the cathode chamber 506. In other aspects, water may be removed via the concentration reactor during every second, third, or more cycle of catholyte through the cathode chamber 506. In still other aspects, water may be removed directly from the storage tank 504 or from the cathode chamber506.

Alternatively, or in addition, a supplemental quantity of Fe²⁺ may be supplied to the catholyte stream either as an aqueous solution or as a solid (which may dissolve in the catholyte). In various aspects, the supplemental Fe²⁺ material may be added to the storage tank 504 or directly to the cathode chamber 506.

In some aspects, if the plating catholyte or supplemental solution also contains additional elements such as Mg or Mn as described in various aspects herein, re-concentrating the plating catholyte will also concentrate the other element(s). Proceeding through enough cycles, the concentration of the other materials may approach solubility limits, risking the precipitation of compounds of those materials within the cathode chamber 506, which may be deleterious to the quality of the plates.

In such cases, a “bleed stream” (as known to those skilled in the art of electrowinning) may be drawn from the catholyte. The bleed stream will remove a portion of electrolyte from the catholyte flow stream. In some aspects, the bleed stream may be replaced by water or other supporting solution. The bleed stream may be treated such as by removing water (as described herein), by precipitation driven by a pH shift (as described herein), or by a recrystallization process (as described herein) to remove dissolved constituents such as Mn, Mg, and Fe.

In some aspects Fe may be removed from a bleed stream by precipitation as Fe(OH)₂ which may provide a source of Fe(OH)₂ for the reactor 512. Alternatively, Fe may be removed from a bleed stream by recrystallization as (for example) FeSO₄ which may be returned to the tank 504 as a supplemental source of Fe²⁺ ions.

Similarly, the other constituents (e.g., Mn and Mg) may be removed by any of the methods and as any of the products described herein.

### Reusing Slag-Recovered Materials in Steelmaking

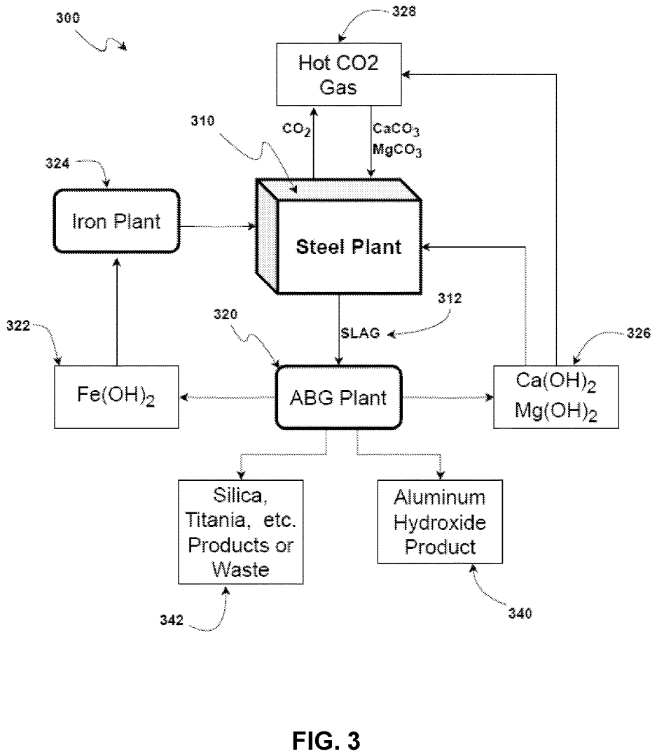

FIG. 3 illustrates a process 300 for re-using materials extracted from a steelmaking slag in a steelmaking plant. As described in various aspects above, an ABG plant 320 may be used to extract materials from steelmaking slag 312. The steelmaking slag in FIG. 3 may be any slag from any steelmaking plant (i.e, the same steelmaking plant or a different plant from the plant to which it will be recycled), including steel slag, iron slag, blast furnace slag, basic oxygen furnace slag, EAF slag, ladle slag, etc. As also described above, products extracted from the slag may include iron (Ill) hydroxide, iron (II) hydroxide 322, calcium hydroxide and/or magnesium hydroxide 326 or their respective oxides (e.g., CaO, MgO, and FeOx with x reflecting the possible different oxidation state of iron, x=1 for Fe (II) and x=1.5 for Fe(III) or an intermediate value between 12 and 1.5).

As shown in FIG. 3, iron hydroxide or oxide extracted from slag 312 may be reduced to metallic iron in an iron plant 324. The iron plant may comprise any suitable technologies or methods for removing oxygen (i.e., reducing the oxide) to form metallic iron. Such methods may include blast furnace, natural gas direct reduction, hydrogen direct reduction, dissolution and electrolytic deposition, etc. The metallic iron may then be returned to the steel plant 310 to make steel.

In some aspects, some or all of the calcium and magnesium hydroxides 326 (or dehydrated oxides CaO and/or MgO) may be returned directly to the steel plant 310 for use as flux in order to aid in protecting refractory materials and/or to aid in producing slag in a new steelmaking operation.

Alternatively or in addition, all or a portion of the calcium and/or magnesium hydroxides 326 may be used to capture CO₂ 328 from the steel plant 310 or from another CO₂-emitting plant such as an electrical power plant (not shown) or the iron plant 324. Calcium and magnesium hydroxides readily form carbonates when exposed to a carbon dioxide containing gas, especially at high temperatures. Therefore, by contacting the solid calcium and/or magnesium hydroxides 326 with hot (e.g., 200 to 600° C.) CO₂-containing flue gas 328 from the steel plant 310 or other plant, the hydroxides 326 may be converted into calcium carbonate and/or magnesium carbonate, which may also be used as flux in a steelmaking operation. For example, in some aspects, a gas containing carbon dioxide (at ambient temperature or elevated temperature of 200° C. to 500° C. or more) may be flowed through a column containing solid calcium hydroxide and/or magnesium hydroxide to form respective carbonates. In other aspects a gas or gas mixture containing carbon-dioxide may be bubbled through an aqueous slurry of water and solid calcium hydroxide and/or magnesium hydroxide. In some aspects, the calcium carbonate and/or magnesium carbonate so produced may be pelletized prior to using it as flux.

Alternatively or in addition, all or a portion of the calcium hydroxide 326 may be used for cement/clinker making without CO₂ emissions.

In various aspects, extracted silica and/or titania 342, and aluminum hydroxide (or dehydrated aluminum oxide, Al2O₃) and/or aluminum phosphates 340, and any other extracted products may be sold, used, or otherwise disposed.

### Ladle Slag Recycling & Bauxite Processing

The term “ladle slag” refers to an intentionally-formed slag material used during a steel refinement process in a ladle refining furnace. The ladle slag forms a molten layer on top of the molten steel, aiding in removing impurities from the steel, protecting the steel from re-oxidation, and insulating the molten steel from premature cooling. Ladle slag is typically removed from the ladle immediately prior to casting. Ladle slag typically contains substantially the same constituent components as other iron and steel slags (as described herein above), but in significantly different ratios.

Due to common use of calcium aluminate as a major slag component, waste ladle slag tends to contain a large quantity of alumina (Al₂O₃, typically on the order of 30% to 50% by weight) and calcium oxide (typically on the order of about 40% to 60%). Ladle slags also tend to contain a very small quantity of iron oxides (typically less than 1%), and larger quantities of silica and magnesium oxide (both typically on the order of 5 to 10%). By comparison, bauxite ores mined for their aluminum content typically contain about 30% to 60% alumina, about 3% to 20% silica, and about 20% to about 33% iron oxides. Therefore, in terms of elemental composition, ladle slag resembles bauxite ore with a very low iron content.

As such, in some aspects, ladle slag may be ground and processed by the Bayer process in place of bauxite to produce alumina while producing dramatically less red mud waste. Using the Bayer process, ladle slag may be ground, crushed, or otherwise milled to small particles, then leached with sodium hydroxide (or other base), and filtered to remove undissolved solids (predominantly iron oxide which creates the red color of red mud). The filtered alumina-containing solution is then cooled to precipitate/crystallize aluminum hydroxide which is then dehydrated to produce aluminum oxide of sufficient purity to be smelted into aluminum metal.

In further aspects of inventions described herein, ladle slag or bauxite ore may be processed as described in various aspects herein using electrochemically-produced acid and base to precipitate a separate aluminum hydroxide product that may be subsequently smelted to produce aluminum metal, e.g., in a smelting cell using the Hall-Héroult process or other suitable aluminum smelting process. A process for extracting alumina from a ladle slag or a bauxite ore may proceed substantially as illustrated and described herein with reference to FIG. 1, but in some aspects, the Fe³⁺ reduction step may be omitted due to the low quantity of iron present. As with aspects described elsewhere herein, calcium hydroxide and/or magnesium hydroxide may be dehydrated, pelletized, and used as flux in a new steelmaking process.

In further aspects, products obtained by any of the aspects herein may be used in cement making. Cement is generally made by calcining calcium carbonate (limestone) to produce calcium oxide in a kiln in the presence of silicon, aluminum, iron and other ingredients. In some aspects, calcium hydroxide (or calcium oxide) may be used in place of limestone in a standard cement-making process, thereby eliminating the emission of CO₂ gas from the calcining process. Thus, the calcium hydroxide (or calcium oxide) may be heated along with iron, aluminum, silicon, and other materials (from processes described herein or other sources) in order to produce clinker. Alternatively, the calcium hydroxide may be used directly as portland cement.

In further aspects, calcium hydroxide (and/or calcium oxide) and aluminum hydroxide (and/or aluminum oxide) may be heated to a temperature of about 1,400° C. to produce a calcium aluminate product which may be used as flux in a new steelmaking operation.

### Further Acid Base Generation System Examples

In place of or in combination with the electrochemical acid-base generation system of FIG. 4 described above, any other electrochemical acid base generation system (or combinations of systems) may be used to produce acid and base used in any of the processes or systems, and aspects thereof, described herein. Some example aspects of acid base generation systems are described in PCT Publication WO/2022/197954 titled “Carbon Capture Using Electrochemically-Produced Acid And Base” (hereinafter the “'954 publication”) which is incorporated herein by reference in its entirety to the extent not inconsistent herewith. Any acid base generation system described in the '954 publication may be used in any of the processes or systems described herein and aspects thereof.

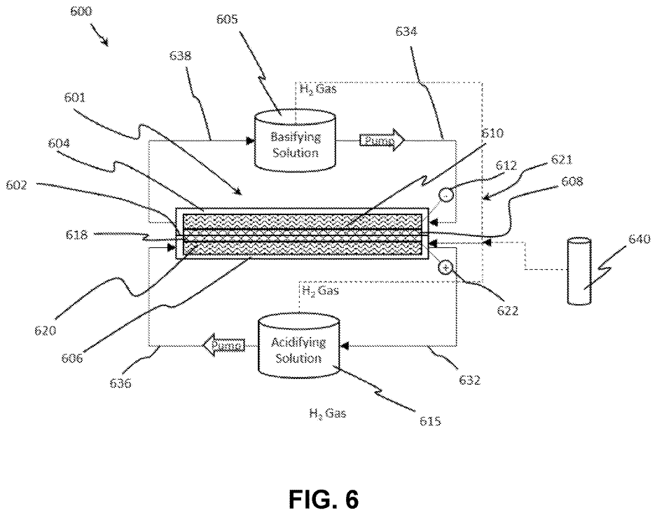

FIG. 6 schematically illustrates an electrolytic acid-base generation system 600, which may be configured to operate with either an AEM or a PEM separator membrane dividing the cell into two chambers. In either case, the system may be configured to circulate an “acidifying solution” liquid and a “basifying solution” liquid through an electrolytic reactor in which constituents of the liquids are treated to convert a portion of the acidifying solution liquid into an acid and a portion of the basifying solution liquid into a base.

The system 600 generally comprises at least one electrolytic cell 601 which may include a separator membrane 602 dividing the cell 601 into a cathode chamber 604 and an anode chamber 606. The cathode chamber 604 may contain a cathode electrode 608 and current collector 610 connected to a negative terminal 612, and the anode chamber 606 may contain an anode electrode 618 and current collector 620 connected to a positive terminal 622. The cathode chamber 604 may further include a fluid inlet into which a “basifying solution” solution may flow and a fluid outlet through which basifying solution may exit after treatment in the cathode chamber 604. The basifying solution may be stored in a basifying solution vessel 605 which may have a volume many times larger than the cell 601 (or collection of cells).

Similarly, the anode chamber 606 may include a fluid inlet into which an “acidifying solution” solution may flow and a fluid outlet through which acidifying solution may exit after treatment in the cathode chamber 606. The acidifying solution may be stored in an acidifying solution vessel 615 which may have a volume many times larger than the cell 601 (or collection of cells). Acidifying solution and basifying solution may flow into the cell via respective in-flow conduits 636, 634 and after exiting the cell 601 may be returned to the respective vessels 615, 605 via return conduits 632, 638. In some aspects, the basifying solution and acidifying solution may be circulated by respective pumps and/or other flow control devices. In various aspects, the acidifying and basifying solutions may be configured to flow through an acid base generator (of any type or configuration described herein) in the same direction (co flow) or in the opposite direction (counter flow) in the cell.

As the acidifying solution and basifying solution (and in some cases a gaseous reactant such as hydrogen) flow through the cell, an electrical current applied to the electrodes will typically cause electrolytic reactions modifying ions in the liquids, resulting in an increase in concentration of a basifying solution product (i.e., a base solution) and a corresponding increase in concentration of an acidifying solution product (i.e., an acid solution). As will be further described below, the acidifying solution exiting the anode chamber 606 will typically contain an increased concentration of the acidic anode product in addition to a decreased concentration of un-reacted components of the supplied acidifying solution. Similarly, the basifying solution exiting the cathode chamber 604 will typically contain an increased concentration of the basic anode product in addition to a decreased concentration of un-reacted component of the supplied basifying solution.

According to some aspects, the intended electrochemical reaction at the cathode involves water-splitting to produce hydrogen gas and hydroxyl ions according to the equation:

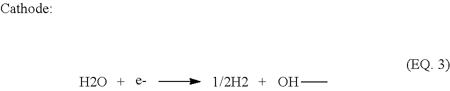

The system may comprise hydrogen gas circulation conduits 621 which may collect hydrogen gas produced in the cathode chamber 604 and direct the collected hydrogen gas along with an optional supplemental hydrogen gas from a hydrogen source 640 into the anode chamber 606 of the cell 601. While FIG. 6 schematically illustrates introduction or injection of hydrogen gas directly into the anode chamber of the cell, the hydrogen gas may be introduced or injected into the acidifying solution at any point between an acidifying solution tank and the anode chamber(s) of the cell or cell-stack. For example, in some aspects, the hydrogen gas may be injected into an acidifying solution conduit upstream of the cell or cell-stack. In various aspects, hydrogen gas may be mixed into the acidifying solution by a sparger and/or other gas-liquid mixing device. Such hydrogen injection and/or mixing methods and systems may be used in combination with any of the aspects described herein.

In aspects configured to consume gaseous hydrogen at the anode, the intended electrochemical reaction at the anode may comprise hydrogen oxidation in which hydrogen gas is oxidized to form protons according to the equation:

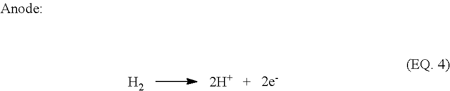

One or both of the acidifying solution and the basifying solution may comprise an aqueous solution having anions and cations from one or more dissolved salts. Depending on the ion selectivity of the separator membrane, either the salt anion or the salt cation may pass through the separator membrane and interact with species in the opposite chamber.

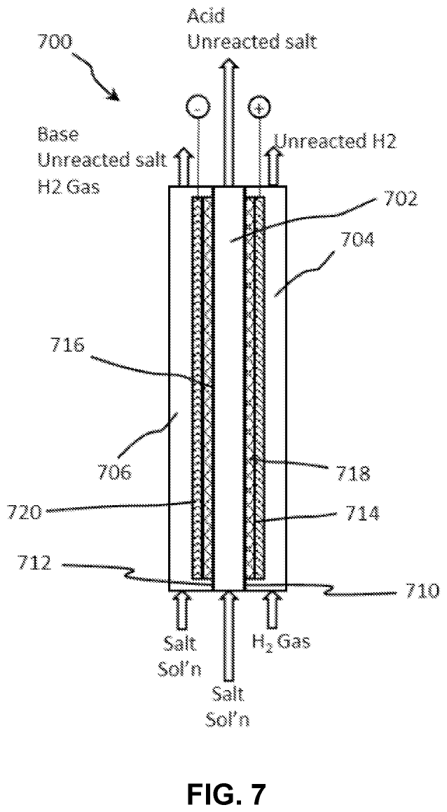

FIG. 7 illustrates an electrolytic acid-base generator configured to operate with a three-chamber cell 700 (or a stack or other bundle of such cells), similar to the configuration described above with reference to FIG. 4. In such aspects, a middle chamber 702 is separated from an anode chamber 704 by a first separator membrane 710 and from a cathode chamber 706 by a second separator membrane 712. The anode electrode 718 and the cathode electrode 716 may each be in contact with a respective current collector 714, 720. In some aspects, the anode chamber may contain substantially only hydrogen gas, a first salt solution may be driven to flow through the middle chamber, and a second salt solution (which may comprise the same salt(s) or a different salt than the first salt solution) or water may be driven to flow through the cathode chamber.

In some aspects, the first separator membrane 710 may be a PEM separator and the second separator membrane 712 may be an AEM separator. In such aspects, protons produced at the anode by oxidation of hydrogen gas may cross the PEM (first) separator 710 into the middle chamber 702 into which a salt solution may be directed. Concurrently, a salt anion (e.g., Cl⁻ in the above example) may cross the AEM (second) separator 712 from the cathode chamber 706 into the middle chamber 702. The protons (H⁺) and salt anions (e.g., Cl⁻) in the middle chamber 702 may combine to form an acid (e.g., HCl). Concurrently, the hydroxyl anions (OH⁻) from water reduction and the salt cations (e.g., Na⁺) in the cathode chamber may combine to form a base.

In some aspects, the middle chamber 702 may be configured to be as narrow as possible to provide the smallest possible distance between the anode electrode and the cathode electrode. For example, in some aspects, the middle chamber may be limited to a thickness on the order of about 0.1 mm or less up to about two centimeters. In some aspects, a middle chamber may have a width of about 0.2 mm to about 10 mm (1 cm). Larger anode-cathode gaps will cause increased ohmic resistance in the cell (particularly in bipolar cell-stacks). Therefore, while gaps greater than 1 or 2 cm are possible, smaller gaps may provide more energy efficient operation. For example, in some aspects, the middle chamber 702 comprises a (preferably electrically non-conductive) porous flow-through material that may be compressed between the anode-side separator and the cathode-side separator. In various aspects, a flow-through material in a middle chamber 702 may comprise a mesh, a felt, a corrugated structure, ribs, vanes, or other structures suitable for maintaining a flow channel while minimizing a distance between electrode-separator contact planes, or any combination thereof.

As described above, the hydroxyl anion (OH⁻) produced at the cathode may compete with the salt anion to cross the AEM separator. Any of the various methods for increasing the probability of the salt anion crossing the AEM instead of the hydroxyl anion described elsewhere herein may be used in a three-chamber system as well.

In other aspects, both the first separator membrane 710 and the second separator membrane 712 may be PEM separators. In such aspects, protons produced at the anode by oxidation of hydrogen gas may cross the first PEM separator 710 into the middle chamber 702. The protons (H⁺) and salt anions (e.g., Cl⁻) in the middle chamber 702 may combine to form an acid (e.g., HCl) in the middle chamber 702. Concurrently, a salt cation (e.g., Na⁺ in the above example) may cross the second PEM separator 712 from the middle chamber 702 into the cathode chamber 706. The salt cations (e.g., Na⁺) in the cathode chamber may combine with hydroxyl (OH⁻) produced by the reduction of water at the anode to form a base (e.g., NaOH).

In various aspects, acid and base may be produced in an electrodialytic bipolar membrane based system. Such systems for acid-base generation (i.e., electrodialytic acid base generators) typically comprise CEM (or PEM), AEM and bipolar membranes as depicted in FIG. 8.

The process of electrodialysis with bipolar membranes combines electrodialysis for salt separation with electrodialytic water splitting for the conversion of a salt into its corresponding acid and base. The bipolar membranes enhance the splitting of water into protons and hydroxide ions. Bipolar membranes are a special type of layered ion exchange membrane comprising an AEM that is selectively permeable to anions and a cation exchange membrane (CEM) or proton exchange membrane (PEM) that is selectively permeable to protons and/or other cations.

A bipolar electrodialysis cell refers to an electrodialysis cell that includes at least one bipolar membrane. The bipolar membrane disassociates water into hydronium ions and hydroxyl ions on application of an electrical field. These generated ions combine with cations and anions from a process stream that includes salts, where the cations and anions are separated by one or more ion exchange membranes in the electrodialysis cell. The combination of the hydronium ions with the anions, and the hydroxyl ions with the cations, results in produced streams having acid and base.

A bipolar electrodialysis cell may be a two-compartment cell or a three-compartment cell. A two-compartment cell includes either a cation-exchange membrane or an anion-exchange membrane between two bipolar membranes. The choice of using a cation-exchange membrane or an anion-exchange membrane depends on which salts are being processed. Cation-exchange membranes may be used to process solutions having salts of weak acids and strong bases, such as sodium salts of organic and amino acids. Anion-exchange membranes are used to process solutions having salts of weak bases and strong or weak acids, such as ammonium salts of chloride, sulfate or lactate.

A three-compartment cell such as that shown in FIG. 8 includes an anion-exchange membrane and a cation-exchange membrane between two bipolar membranes, thereby forming three compartments. The first compartment 802 is an acidic solution-producing compartment 802 between the first bipolar membrane (at left in FIG. 8) and the anion-exchange membrane (AEM). The second compartment 804 is a basic solution-producing compartment 804 between the second bipolar membrane (at right in FIG. 8) and the cation-exchange membrane (CEM). The third compartment 806 is between the cation-exchange membrane and the anion-exchange membrane that produces a salt-reduced solution as anions are driven out of the third compartment 806 into the acidifying first compartment 802 and cations are driven out of the third compartment 806 into the basifying second compartment 804. A three-compartment electrodialysis cell is well-suited for recovering an inorganic acid and base from its corresponding salt. In the example illustrated in FIG. 8, a sodium chloride (NaCl) salt is split into hydrochloric acid (HCl) and sodium hydroxide (NaOH).

In some aspects, an electrodialytic system may be used to concentrate acid produced by an electrolytic acid base generator such as those described herein.

Any electrodialytic acid base generator may also be used in a recirculating configuration with acid and base storage tanks to concentrate the acid and base products in the tanks until desired concentrations are reached as described herein with reference to electrolytic acid base generators. This further allows for decoupling of production and use of acid and base solutions.

Other electrodialytic acid base generation systems are shown and described in U.S. Pat. No. 8,778,156, US20210069645, U.S. Pat. Nos. 9,586,181, 9,862,643, and 9,873,650, which are incorporated herein by reference for all purposes.

### Certain Exemplary Aspects and Embodiments

Various aspects are contemplated and disclosed herein, several of which are set forth in the paragraphs below. It is explicitly contemplated and disclosed that any aspect or portion thereof can be combined to form an aspect. In addition, it is explicitly contemplated and disclosed that: any reference to Aspect 1 includes reference to Aspects 1a, 1b, and/or 1c and any combination thereof (i.e., any reference to an aspect includes reference to that aspect's lettered versions). Moreover, the terms “any preceding aspect” and “any one of the preceding aspects” means any aspect that appears prior to the aspect that contains such phrase (for example, the sentence “Aspect 15: The material, device, electrolyte, or method of any preceding Aspect . . . ” means that any Aspect prior to Aspect 15 is referenced, including letter versions). For example, it is contemplated and disclosed that, optionally, any composition, method, or formulation of any the below aspects may be useful with or combined with any other aspect provided below. Further, for example, it is contemplated and disclosed that any embodiment or aspect described above may, optionally, be combined with any of the below listed aspects or any portion(s) thereof.

Aspect 1a: A method of recycling a first slag, comprising:
dissolving the first slag with a first acid to form a starting leachate solution;
   wherein the starting leachate solution comprises at least dissolved (aqueous) aluminum ions, dissolved iron ions, dissolved (aqueous)magnesium ions, and dissolved (aqueous)manganese ions;
first precipitating one or more first precipitated products from the starting leachate solution by combining a first base with the starting leachate solution to increase its pH thereby forming a first pre-plating leachate fraction;
   wherein the one or more first precipitated products comprise one or more precipitated aluminum-containing products;
   wherein the first pre-plating leachate fraction comprises dissolved (aqueous) iron ions, magnesium ions, and manganese ions;
first electroplating metallic iron from the first pre-plating leachate fraction using a first electrochemical cell, forming electroplated metallic iron and a first post-plating leachate fraction;
   wherein the first post-plating leachate fraction has a reduced concentration of said iron ions compared to the first pre-plating leachate fraction;
second precipitating one or more second precipitated products from the first post-plating leachate fraction by combining a second base with the first post-plating leachate fraction to increase its pH thereby forming a second leachate fraction;
   wherein the one or more second precipitated products comprise one or more precipitated manganese-containing products; and
third precipitating one or more third precipitated products from the second leachate fraction by combining a third base with the second leachate fraction to increase its pH thereby forming a third leachate fraction;
   wherein the one or more third precipitated products comprise one or more precipitated magnesium-containing products.

Aspect 1b: A system for performing the method of Aspect 1a.

Aspect 1c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 1a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 1a.

Aspect 2: The method or system of Aspect 1, wherein the first electrochemical cell comprises a first electroplating catholyte, the first electroplating catholyte comprising the first pre-plating leachate fraction, such that the first electroplating catholyte comprises the dissolved (aqueous) iron ions, magnesium ions, and manganese ions.

Aspect 3: The method or system of Aspect 2, comprising separately dosing the first electroplating catholyte with iron hydroxide. Optionally, the dosing is performed as one or more discrete steps during the step of first electroplating. Optionally, the dosing is performed continuously during at least a portion of the step of electroplating. Dosing the catholyte with iron hydroxide helps to consume acid that may leak into the catholyte through an anion exchange membrane. Accordingly, optionally, the amount and/or rate of dosing of iron hydroxide is within 50% (optionally within 40%, optionally within 30%, optionally within 20%, optionally within 10%, optionally within 5%) of the amount and/or rate of acid leakage into the catholyte from the respective anolyte across the respective membrane or separator.

Aspect 4: The method or system of Aspect 2 or 3, wherein the first electroplating catholyte comprises:
dissolved (aqueous) magnesium ions having a concentration selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein,
dissolved (aqueous) manganese ions having a concentration selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein, and/or
dissolved (aqueous) calcium ions having a concentration selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein.

Aspect 5: The method or system of any of the preceding Aspects, wherein the step of first electroplating metallic iron is performed against an electrochemical oxygen evolution reaction at a first anode.

Aspect 6: The method or system of Aspect 5, wherein a first electrochemical cell comprises the first anode in the presence of a first anolyte, a first cathode in the presence of a first electroplating catholyte, and an anion exchange membrane separating the first electroplating catholyte from the first anolyte;
wherein the first electroplating catholyte comprises the first pre-plating leachate fraction and the metallic iron is electroplated at the first cathode.

Aspect 7: The method or system of any of the preceding Aspects further comprising:
producing a produced acid and a produced base in an electrochemical acid-base generator;
wherein the first acid comprises the produced acid; and
wherein each of the first base, the second base, and the third base comprises a portion of the produced base.

Aspect 8: The method or system of Aspect 7 comprising:
returning a neutralized salt solution to the electrochemical acid-base generator; and
re-producing the produced acid and the produced base from the neutralized salt solution via the electrochemical acid-base generator.

Aspect 9: The method or system of any of the preceding Aspects further comprising first providing at least a portion of the first, second, and/or third precipitated products, with or without further processing thereof, to a steelmaking furnace.

Aspect 10: The method or system of Aspect 9, wherein said step of providing comprises converting said provided at least the portion of the first, second, and/or third precipitated products into respective metallic products and/or metal oxide products and then providing said converted respective metallic products and/or metal oxide products to said steelmaking furnace.

Aspect 11: The method or system of any of the preceding Aspects, wherein the third precipitated products comprise magnesium hydroxide and/or calcium hydroxide; and wherein the method comprises converting the magnesium hydroxide and/or calcium hydroxide to magnesium oxide and/or calcium oxide, respectfully, and providing the magnesium oxide and/or calcium oxide as a flux in a steelmaking furnace.

Aspect 12: The method or system of any one of Aspects 9-11 comprising:
collecting a new steel slag from the steelmaking furnace; and repeating the method using the new steel slag.

Aspect 13: The method or system of Aspect 12, comprising dissolving the new steel slag in the first or a second acid to form a new starting leachate solution.

Aspect 14: The method any of the preceding Aspects, comprising providing at least a portion of the electroplated metallic iron to a steelmaking furnace.

Aspect 15: The method or system of any one the preceding Aspects, comprising producing at least a portion of each of the first acid, the second acid, the first base, the second base, and the third base using an electrochemical acid-base generator.

Aspect 16: The method or system of any of the preceding Aspects, comprising first collecting at least a portion of a spent catholyte from the step of first electroplating and concentrating the collected spent catholyte.

Aspect 17: The method or system of Aspect 16, wherein the spent catholyte, prior to concentrating, has a dissolved (aqueous) iron ion concentration selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein, such as optionally selected from the range of 0.2 M to 1 M.

Aspect 18: The method or system of Aspect 16 or 17, comprising, after the step of concentrating, a step of Mn-precipitating one or more precipitated manganese-containing products from the concentrated spent catholyte.

Aspect 19: The method or system of Aspect 18, wherein the step of second precipitating comprises the step of Mn-precipitating is the step of second precipitating; wherein the step of Mn-precipitating comprises combining the concentrated spent catholyte with the first post-plating leachate fraction and the base.

Aspect 20: The method or system of any of the preceding Aspects, comprising: removing a bleed stream from the first electroplating catholyte.

Aspect 21: The method or system of Aspect 20, comprising:
concentrating the removed bleed stream by reducing its water content; and
fourth precipitating one or more fourth precipitated products from the concentrated bleed stream by adding a fourth base;
wherein the one or more fourth precipitated products comprise magnesium.

Aspect 22: The method or system of any of the preceding Aspects, wherein a concentration of the dissolved (aqueous) magnesium ions in the first pre-plating leachate fraction is selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein.

Aspect 23: The method or system of any of the preceding Aspects, wherein a concentration of the dissolved (aqueous) manganese ions in the first pre-plating leachate fraction is selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein.

Aspect 24a: A method of recycling a first slag, comprising:
dissolving the first slag with a first acid to form a starting leachate solution;
   wherein the starting leachate solution comprises at least one or more dissolved (aqueous) aluminum ions, dissolved (aqueous) iron ions, and one or more dissolved (aqueous) calcium ions and/or (aqueous) magnesium ions;
first precipitating one or more first precipitated products from the starting leachate solution by combining a first base with the starting leachate solution to increase its pH thereby forming a first leachate fraction;
   wherein the one or more first precipitated products comprise one or more precipitated aluminum-containing products;
second precipitating one or more second precipitated products from the first leachate fraction by combining a second base with the first leachate fraction to increase its pH thereby forming a second leachate fraction;
   wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
   wherein the one or more third precipitated products comprise one or more precipitated calcium-containing products and/or one or more precipitated magnesium-containing products;
wherein the method further comprises:
producing a produced acid and a produced base in an electrochemical acid-base generator;
wherein the first acid comprises the produced acid; and
wherein each of the first base, the second base, and the third base comprises a portion of the produced base.

Aspect 24b: A system for performing the method of Aspect 24a.

Aspect 24c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 24a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 24a.

Aspect 25: The method or system of Aspect 24, further comprising:
returning a neutralized salt solution to the electrochemical acid-base generator; and
re-producing the produced acid and the produced base from the neutralized salt solution via the electrochemical acid-base generator.

Aspect 26a: A method of recycling a first slag, comprising:
dissolving the first slag with a first acid to form a starting leachate solution;
   wherein the starting leachate solution comprises at least one or more dissolved aluminum ions, dissolved iron ions, and one or more dissolved calcium and/or magnesium-containing products;
first precipitating one or more first precipitated products from the starting leachate solution by combining a first base with the starting leachate solution to increase its pH thereby forming a first leachate fraction;
   wherein the one or more first precipitated products comprise one or more precipitated aluminum-containing products;
second precipitating one or more second precipitated products from the first leachate fraction by combining a second base with the first leachate fraction to increase its pH thereby forming a second leachate fraction;
   wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
   wherein the one or more third precipitated products comprise one or more precipitated calcium-containing products and/or one or more precipitated magnesium-containing products;
wherein the method further comprises:
providing at least a portion of the one or more third precipitated products as a flux to a steelmaking furnace and/or reducing at least a portion of the precipitated iron-containing products to metallic iron and using said metallic iron in the steelmaking furnace;
collecting a new steel slag from the steelmaking furnace; and
repeating the method using the new steel slag.

Aspect 26b: A system for performing the method of Aspect 26a.

Aspect 26c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 26a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 26a.

Aspect 27: The method or system of Aspect 26 comprising providing at least a portion of the one or more third precipitated products as a flux to a steelmaking furnace

Aspect 28: The method or system of Aspect 26 or 27, wherein the third precipitated products comprise magnesium hydroxide and/or calcium hydroxide; wherein the method comprises converting the magnesium hydroxide and/or calcium hydroxide to magnesium oxide and/or calcium oxide, respectfully; and wherein the step of providing comprises providing the magnesium oxide and/or calcium oxide as the flux in the steelmaking furnace.

Aspect 29: The method or system of any one of Aspects 26-28 comprising reducing at least a portion of the precipitated iron-containing products to metallic iron and using said metallic iron in the steelmaking furnace.

Aspect 30: The method or system of any one of Aspects 26-29 comprising dissolving the new steel slag in the first acid or a second acid to form a new starting leachate solution.

Aspect 31: The method or system of any one of Aspects 26-30 comprising producing at least a portion of each of the first acid, the second acid, the first base, the second base, and the third base using an electrochemical acid-base generator.

Aspect 32: The method or system of any of the preceding Aspects, wherein the step of dissolving comprises separating undissolved solids from the starting leachate solution; wherein the undissolved solids comprise silica, titania, and/or calcium sulfate.

Aspect 33: The method or system of Aspect 32, wherein the undissolved solids comprise calcium sulfate; and wherein the method further comprises physically separating the calcium sulfate from other undissolved solids and redissolving (optionally in a base, optionally in a hydroxide base) the separated calcium sulfate to form solid precipitated calcium hydroxide and an aqueous dissolved sulfate salt.

Aspect 34: The method or system of Aspect 33, comprising returning the aqueous dissolved sulfate salt into an electrochemical acid-base generator.

Aspect 35: The method or system of any of the preceding Aspects comprising milling the first slag to decrease its particle size prior to the step of dissolving said first slag.

Aspect 36: The method or system of Aspect 34, comprising magnetically separating and removing magnetic components from the milled slag prior to the step of dissolving said first slag.

Aspect 37: The method or system of any of the preceding Aspects, wherein the first acid comprises one or more weak acids.

Aspect 38: The method or system of any of the preceding Aspects, wherein the first acid comprises an aqueous bisulfate acid.

Aspect 39: The method or system of Aspect 38, wherein the aqueous bisulfate acid comprises an alkali bisulfate, an ammonium bisulfate, or a combination thereof.

Aspect 40: The method or system of Aspect 38 or 39, wherein the aqueous bisulfate acid is produced using an electrochemical acid-base generator.

Aspect 41: The method or system of any of the preceding Aspects, wherein the first acid comprises sulfuric acid.

Aspect 42: The method or system of any of the preceding Aspects, wherein the first acid comprises hydrochloric acid.

Aspect 43: The method or system of any of the preceding Aspects comprising reducing ferric ions to ferrous ions in the starting leachate solution prior to the step of first precipitating.

Aspect 44: The method or system of Aspect 43, wherein the step of reducing ferric ions to ferrous ions is performed electrochemically.

Aspect 45: The method or system of Aspect 43 or 44, wherein the step of reducing ferric ions to ferrous ions is performed chemically by providing the ferric ions in the presence of a reducing agent.

Aspect 46: The method or system of Aspect 45, wherein the reducing agent is metallic iron, a steel, or another metal comprising iron.

Aspect 47: The method or system of any one of Aspects 43-46, wherein reducing ferric ions to ferrous ions comprises recirculating the leachate solution between a dissolution vessel and a cathode chamber of an electrochemical acid regeneration cell configured to cathodically reduce the ferric ions to ferrous ions while anodically evolving oxygen gas and liberating protons that are transported into the leachate solution in the cathode chamber.

Aspect 48: The method or system of any of the preceding Aspects, wherein the first base, the second base, the third base, or any combination thereof comprises calcium hydroxide, ferric hydroxide, ferrous hydroxide, metallic iron, and/or magnesium hydroxide.

Aspect 49: The method or system of any of the preceding Aspects, where each step of first precipitating, second precipitating, third precipitating, or any combination thereof is performed at liquid temperature (temperature of the aqueous solution from which solid precipitate) selected from the range of approximately 50° C. (optionally approximately 55° C., optionally approximately 60° C., optionally approximately 65° C., optionally approximately 70° C., optionally approximately 75° C.) to approximately 90° C. (optionally approximately 85° C., optionally approximately 80° C.), such as optionally approximately 60° C.±5° C., optionally approximately 70° C.±5° C., optionally approximately 80° C.±5° C.

Aspect 50: The method or system of any of the preceding Aspects, wherein:
the one or more precipitated aluminum-containing products comprise aluminum hydroxide,
the one or more precipitated iron-containing products comprise iron(II) hydroxide (ferrous hydroxide),
the one or more precipitated calcium-containing products comprise calcium hydroxide, and
the one or more precipitated magnesium-containing products comprise magnesium hydroxide.

Aspect 51: The method or system of any of the preceding Aspects, wherein the one or more first precipitated products also comprise one or more precipitated chromium-containing products.

Aspect 52: The method or system of any of the preceding Aspects, wherein the one or more first precipitated products also comprise one or more precipitated phosphorous-containing products or one or more precipitate phosphate-containing products.

Aspect 53: The method or system of any of the preceding Aspects, wherein the one or more second precipitated products also comprise one or more precipitated manganese-containing products.

Aspect 54: The method or system of any of the preceding Aspects, wherein the starting leachate solution has a pH less than or equal to approximately 2.5, optionally less than or equal to approximately 2.3, optionally less than or equal to approximately 2.2, optionally less than or equal to approximately 2.1, optionally less than or equal to approximately 2.0, optionally less than or equal to approximately 1.9, optionally less than or equal to approximately 1.8, optionally less than or equal to approximately 1.7, optionally less than or equal to approximately 1.6, optionally less than or equal to approximately 1.4, optionally less than or equal to approximately 1.2, optionally less than or equal to approximately 1.1, optionally less than or equal to approximately 1.0, optionally less than or equal to approximately 0.9, optionally less than or equal to approximately 0.8, optionally less than or equal to approximately 0.7, optionally less than or equal to approximately 0.5.

Aspect 55: The method or system of any of the preceding Aspects, wherein the first leachate fraction has a pH selected from the range of approximately 2.5 (optionally approximately 2.6, optionally approximately 2.7, optionally approximately 2.8, optionally approximately 2.9, optionally approximately 3.0, optionally approximately 3.1) to approximately 5.7 (optionally approximately 5.6, optionally approximately 5.5, optionally approximately 5.4, optionally approximately 5.3, optionally approximately 5.2, optionally approximately 5.1, optionally approximately 5.0, optionally approximately 4.9, optionally approximately 4.8, optionally approximately 4.6, optionally approximately 4.5, optionally approximately 4.4, optionally approximately 4.3, optionally approximately 4.2, optionally approximately 4.1, optionally approximately 4.0, optionally approximately 3.9, optionally approximately 3.8).

Aspect 56a: The method or system of any of the preceding Aspects, wherein the second leachate fraction has a pH selected from the range of approximately 6.4 (optionally approximately 6.5, optionally approximately 6.6, optionally approximately 6.7, optionally approximately 6.8, optionally approximately 6.9, optionally approximately 7.0, optionally approximately 7.1, optionally approximately 7.2, optionally approximately 7.3, optionally approximately 7.4, optionally approximately 7.5, optionally approximately 7.6, optionally approximately 7.7, optionally approximately 7.8) to approximately 9.2 (optionally approximately 9.1, optionally approximately 9.0, optionally approximately 8.9, optionally approximately 8.8, optionally approximately 8.7, optionally approximately 8.6, optionally approximately 8.5, optionally approximately 8.4, optionally approximately 8.3, optionally approximately 8.2). Aspect 56b: The method or system of any of the preceding Aspects, wherein the second leachate fraction has a pH selected from the range of approximately 6.4 (optionally approximately 6.5, optionally approximately 6.6, optionally approximately 6.7, optionally approximately 6.8, optionally approximately 6.9, optionally approximately 7.0, optionally approximately 7.1, optionally approximately 7.2, optionally approximately 7.3, optionally approximately 7.4, optionally approximately 7.5, optionally approximately 7.6, optionally approximately 7.7, optionally approximately 7.8) to approximately 10 (optionally approximately 9.9, optionally approximately 9.8, optionally approximately 9.7, optionally approximately 9.6, optionally approximately 9.5, optionally approximately 9.4, optionally approximately 9.3, optionally approximately 9.2, optionally approximately 9.1, optionally approximately 9.0, optionally approximately 8.9, optionally approximately 8.8, optionally approximately 8.7, optionally approximately 8.6, optionally approximately 8.5, optionally approximately 8.4, optionally approximately 8.3, optionally approximately 8.2).

Aspect 57: The method or system of any of the preceding Aspects, wherein the third leachate fraction has a pH selected from the range of approximately 9.5 (optionally approximately 9.6, optionally approximately 9.7, optionally approximately 9.8, optionally approximately 9.9, optionally approximately 10.0, optionally approximately 10.1, optionally approximately 10.2, optionally approximately 10.4, optionally approximately 10.5, optionally approximately 10.6, optionally approximately 10.7, optionally approximately 10.8, optionally approximately 10.9, optionally approximately 11.0) to approximately 13 (optionally approximately 12.9, optionally approximately 12.8, optionally approximately 12.7, optionally approximately 12.6, optionally approximately 12.5, optionally approximately 12.4, optionally approximately 12.3, optionally approximately 12.2, optionally approximately 12.1, optionally approximately 12.0, optionally approximately 11.9, optionally approximately 11.8, optionally approximately 11.7, optionally approximately 11.6, optionally approximately 11.5).

Aspect 58: The method or system of any of the preceding Aspects, wherein the one or more first, second, and/or third precipitated products comprise metal hydroxide products; and wherein the method further comprises:
dehydrating at least a portion of the metal hydroxides (optionally at least a portion of the metal hydroxides derived from the third precipitated products) to form respective metal oxide products.

Aspect 59: The method or system of Aspect 58 comprising using at least a portion of the formed metal oxide products as at least a portion of a flux in the steelmaking furnace.

Aspect 60a: The method or system of Aspect 59, wherein the formed metal oxide products comprise magnesium oxide, calcium oxide, and/or aluminum oxide. Aspect 60b: The method or system of Aspect 59, wherein the formed metal oxide products consist essentially of magnesium oxide, calcium oxide, and/or aluminum oxide. Aspect 60c: The method or system of Aspect 59, wherein the formed metal oxide products consist essentially of magnesium oxide and/or calcium oxide.

Aspect 61: The method or system of any one of Aspects 58-60, wherein the first precipitated products comprise magnesium hydroxide and wherein the method comprises dehydrating the magnesium hydroxide to form magnesium oxide and using the formed magnesium oxide as at least a portion of the flux in the steelmaking furnace.

Aspect 62: The method or system of any one of Aspects 57-59, wherein the third precipitated products comprise calcium hydroxide and wherein the method comprises dehydrating the calcium hydroxide to form calcium oxide and using the formed calcium oxide as at least a portion of the flux in the steelmaking furnace.

Aspect 63: The method or system of any one of Aspects 58-62, wherein the second precipitated products comprise an iron hydroxide and wherein the method comprises dehydrating the iron hydroxide to form an iron oxide, reducing the iron oxide to metallic iron, and using the formed metallic iron in the steelmaking furnace.

Aspect 64: The method or system of any of the preceding Aspects, wherein the one or more precipitated aluminum-containing products comprise aluminum hydroxide; the method further comprising dehydrating precipitated aluminum hydroxide to form alumina (Al₂O₃) and refining the alumina to aluminum metal in an aluminum smelting process.

Aspect 65: The method or system of any of Aspects 58 to 64, wherein dehydrating is performed using waste heat from a steelmaking plant or a power plant.

Aspect 66: The method or system of any of the preceding Aspects, wherein the one or more magnesium-containing products comprise Mg(OH)₂ and the one or more calcium-containing products comprise Ca(OH)₂; and wherein the method comprises contacting the precipitated Mg(OH)₂ and/or Ca(OH)₂ with a CO₂-containing gas to form MgCO₃ and/or CaCO₃, respectively.

Aspect 67: The method or system of Aspect 66, wherein the CO₂-containing gas is at a temperature of at least approximately 200° C. during said step of contacting.

Aspect 68: The method or system of Aspect 66 or 67, wherein the CO₂-containing gas is exhaust or flue gas from the steelmaking furnace.

Aspect 69: The method or system of any one of Aspects 66-68, further comprising using the MgCO₃ and/or CaCO₃ as flux in the steelmaking furnace.

Aspect 70: The method or system of any of the preceding Aspects, wherein the steelmaking furnace is an electric arc furnace.

Aspect 71: The method or system of any of the preceding Aspects, wherein the first slag is a steel slag or an iron slag.

Aspect 72: The method or system of any of the preceding Aspects, wherein the first slag is a ladle slag.

Aspect 73: The method or system of any of the preceding Aspects, wherein the one or more the one or more precipitated calcium-containing products comprise Ca(OH)₂; and wherein the method comprising combining the Ca(OH)₂ with silica, alumina, and iron in a kiln and heating to make clinker.

Aspect 74: The method or system of any one of Aspects 24-73, wherein the one or more second precipitated products comprise magnetite (Fe₃O₄).

Aspect 75: The method or system of Aspect 74 comprising reducing the precipitated magnetite to iron and providing said reduced iron into a steelmaking process or to a steelmaking furnace.

Aspect 76: The method or system of any one of Aspects 24-75, comprising redissolving at least a portion of the one or more metal salts to make a redissolved iron-salt solution; the method further comprising first electroplating metallic iron from the redissolved iron-salt solution.

Aspect 77: The method or system of Aspect 76 comprising first collecting at least a portion of a spent electrolyte from the step of first electroplating and comprising a step of first re-precipitating Fe-containing and/or Mn-containing salts from the collected spent electrolyte.

Aspect 78: The method or system of Aspect 76 or 77 comprising first collecting at least a portion of a spent electrolyte from the step of first electroplating, concentrating the collected spent electrolyte to reduce water content thereof, second electroplating metallic iron from the concentrated spent electrolyte, second collecting at least a portion of spent electrolyte from the second electroplating step, and first re-precipitating Fe-containing and/or Mn-containing salts from the second collected spent electrolyte.

Aspect 79: The method or system of any one of Aspects 24-78, wherein the one or more precipitated iron-containing products comprise Fe(OH)₂.

Aspect 80: The method or system of Aspect 79 comprising heating the Fe(OH)₂ to make FeO.

Aspect 81: The method or system of any one of Aspects 24-80, wherein the one or more iron-containing products comprise iron hydroxide; and wherein the method comprises thermally reducing the iron hydroxide to iron metal.

Aspect 82: The method or system of Aspect 81 comprising using the iron metal to make steel in a steelmaking furnace.

Aspect 83a: A method of electrochemically making metallic iron in the presence of dissolved magnesium and dissolved manganese, the method comprising:
first electroplating metallic iron from a first catholyte at a first cathode against an oxygen evolution reaction at a first anode in the presence of a first anolyte;
   wherein the first catholyte comprises dissolved iron ions, dissolved magnesium ions, and dissolved manganese ions;
   wherein the first catholyte and the first anolyte are separated by an anion exchange membrane; and
   wherein a first electrochemical cell comprises the first cathode, the first catholyte, the first anode, and the first anolyte.

Aspect 83b: A system for performing the method of Aspect 83a.

Aspect 83c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 83a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 83a.

Aspect 84: The method or system of Aspect 83, wherein a concentration of the dissolved magnesium ions in the first catholyte is selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein.

Aspect 85: The method or system of Aspect 83 or 84, wherein a concentration of the dissolved manganese ions in the first catholyte is selected from the range of 0.009 M (optionally 0.01 M, optionally 0.02 M, optionally 0.03 M, optionally 0.04 M, optionally 0.05 M, optionally 0.06 M, optionally 0.07 M, optionally 0.08 M, optionally 0.09 M, optionally 0.10 M, optionally 0.11 M, optionally 0.12 M, optionally 0.13 M, optionally 0.14 M, optionally 0.15 M, optionally 0.16 M, optionally 0.17 M, optionally 0.18 M, optionally 0.19 M, optionally 0.20 M, optionally 0.21 M, optionally 0.22 M, optionally 0.23 M, optionally 0.24 M, optionally 0.25 M, optionally 0.26 M, optionally 0.27 M, optionally 0.28 M, optionally 0.29 M, optionally 0.30 M, optionally 0.31 M, optionally 0.32 M, optionally 0.33 M, optionally 0.34 M, optionally 0.35 M, optionally 0.36 M, optionally 0.39 M, optionally 0.40 M, optionally 0.41 M, optionally 0.44 M, optionally 0.45 M, optionally 0.46 M) to 1.3 M (optionally 1.29 M, optionally 1.28 M, optionally 1.26 M, optionally 1.25 M, optionally 1.24 M, optionally 1.23 M, optionally 1.21 M, optionally 1.20 M, optionally 1.19 M, optionally 1.16 M, optionally 1.15 M, optionally 1.14 M, optionally 1.11 M, optionally 1.10 M, optionally 1.09 M, optionally 1.06 M, optionally 1.05 M, optionally 1.04 M, optionally 1.01 M, optionally 1.00 M, optionally 0.99 M, optionally 0.98 M, optionally 0.96 M, optionally 0.95 M, optionally 0.94 M, optionally 0.91 M, optionally 0.90 M, optionally 0.89 M, optionally 0.86 M, optionally 0.85 M, optionally 0.84 M, optionally 0.81 M, optionally 0.80 M, optionally 0.79 M, optionally 0.76 M, optionally 0.75 M, optionally 0.74 M, optionally 0.71 M, optionally 0.70 M, optionally 0.69 M, optionally 0.66 M, optionally 0.65 M, optionally 0.64 M, optionally 0.61 M, optionally 0.60 M, optionally 0.59 M, optionally 0.56 M, optionally 0.55 M, optionally 0.54 M, optionally 0.51 M, optionally 0.50 M, optionally 0.49 M), wherein any range and value therebetween is explicitly contemplated and disclosed herein.

Aspect 86a: A method of electrochemically making metallic iron, the method comprising:
first electroplating metallic iron from a first catholyte at a first cathode against an oxygen evolution reaction at a first anode in the presence of a first anolyte; and
dosing the first catholyte with iron hydroxide during the step of first electroplating;
wherein the first catholyte comprises dissolved iron ions;
wherein the first catholyte and the first anolyte are separated by an anion exchange membrane; and
wherein a first electrochemical cell comprises the first cathode, the first catholyte, the first anode, and the first anolyte.

Aspect 86b: A system for performing the method of Aspect 86a.

Aspect 86c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 86a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 86a.

Aspect 87a: A method of producing a bisulfate solution, the method comprising:
driving a first sulfate salt solution into an acidifying chamber of an electrochemical acid base generation cell, the first sulfate salt solution having a known concentration of a cations that are counter-ions to sulfate anions in the first sulfate salt solution;
driving a second sulfate salt solution into a basifying chamber of an electrochemical acid base generation cell, the basifying chamber containing a cathode electrode; and
applying an electric current with an applied magnitude across the cathode and an anode of the cell, wherein applying the electric current drives protons into the acidifying chamber at a rate directly proportional to the applied magnitude of the current;
wherein the magnitude of the applied current drives protons into the acidifying chamber at a rate that does not exceed a rate of the cations flowing into the acidifying chamber;
whereby a bisulfate acid solution is formed in the acidifying chamber.

Aspect 87b: A system for performing the method of Aspect 87a.

Aspect 87c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 26a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 87a.

Aspect 88: The method or system of Aspect 87, wherein no more than 0.001 M of sulfuric acid is formed in the acidifying chamber.

Aspect 89: The method or system of Aspect 87 or 88, wherein the cations are sodium cations (Na⁺), lithium cations (Li⁺), or potassium cations (K⁺).

Aspect 90: The method or system of Aspect 87 or 88, wherein the cations are ammonium cations (NH₄⁺).

Aspect 91: The method or system of any one of Aspects 87-90, wherein a base solution is produced in the basifying chamber.

Aspect 92: The method or system of any one of Aspects 87-91, further comprising contacting the bisulfate solution with a metallurgical slag material and leaching metallic constituents of the metallurgical slag material into the bisulfate solution.

Aspect 93: The method or system of any one of Aspects 87-92, wherein applying an electrical current to the anode and cathode of the electrochemical acid base generation cell produces hydrogen gas at the cathode; removing the hydrogen gas from the directing the hydrogen gas to the anode; and oxidizing the hydrogen gas to the protons at the anode.

Aspect 94: The method or system of Aspect 93, wherein the anode is a gas diffusion anode.

Aspect 95: The method or system of any one of Aspects 87-94, wherein the electrochemical acid base generation cell has three chambers, the acidifying chamber, the basifying chamber, and a hydrogen oxidation chamber comprising a hydrogen oxidation anode.

Aspect 96: The method or system of any one of Aspects 87-94, wherein the electrochemical acid base generation cell is a two-chamber electrolytic cell.

Aspect 97a: A method of extracting alumina from bauxite ore, comprising:
dissolving the bauxite ore with a first acid to form a starting leachate solution; wherein the starting leachate solution comprises at least one or more dissolved aluminum ions, dissolved iron ions, and one or both of calcium ions and magnesiumions;
first precipitating one or more first precipitated products from the starting leachate solution by combining a first base with the starting leachate solution to increase its pH thereby forming a first leachate fraction;
   wherein the one or more first precipitated products comprise precipitated aluminum hydroxide;
second precipitating one or more second precipitated products from the first leachate fraction by combining a second base with the first leachate fraction to increase its pH thereby forming a second leachate fraction;
   wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
   wherein the one or more third precipitated products comprise one or more precipitated calcium-containing products and/or one or more precipitated magnesium-containing products; and
dehydrating the precipitated aluminum hydroxide to form alumina (Al₂O₃).

Aspect 97b: A system for performing the method of Aspect 97a.

Aspect 97c: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to Aspect 97a and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the processes and steps of Aspect 97a.

Aspect 98: The method or system of Aspect 97, comprising:
producing a produced acid and a produced base in an electrochemical acid-base generator;
wherein the first acid comprises the produced acid; and
wherein each of the first base, the second base, and the third base comprises a portion of the produced base.

Aspect 99: The method or system of Aspect 97 or 98 comprising reducing ferric ions to ferrous ions in the starting leachate solution prior to the step of first precipitating.

Aspect 100: The method or system of any one of Aspects 97-99 comprising milling the bauxite ore to decrease its particle size prior to the step of dissolving said bauxite ore.

Aspect 101: The method or system of any one of Aspects 97-100 comprising returning the third leachate fraction to the electrochemical acid-base generator and producing new acid and base from recovered salt in the third leachate fraction.

Aspect 102: The method or system of any one of Aspects 97-101, wherein the step of dehydrating is performed using waste heat from a steelmaking plant, a power plant, or an aluminum smelting plant.

Aspect 103: The method or system of any one of Aspects 97-102, further comprising refining precipitated alumina to aluminum metal in an aluminum smelting process.

Aspect 104: The method or system of any one of Aspects 97-103, further comprising heating at least one precipitated hydroxide to dehydrate the at least one precipitated hydroxide, collecting water released during dehydration, and returning the collected water to the electrochemical acid-base generator, wherein the heating is optionally performed using waste heat from a steelmaking plant, a power plant, or an aluminum smelting plant.

Aspect 105: The method or system of any one of Aspects 97-104, wherein the returned remaining leachate solution is neutralized prior to returning.

Aspect 106: The method or system of any one of Aspects 97-105, wherein the step of dehydrating further comprises condensing water vapor produced by the dehydration and recycling the condensed water to the electrochemical acid-base generator.

Aspect 107: The method or system of any preceding Aspect, wherein at least 50%, optionally at least 75%, optionally at least 85%, optionally at least 90%, optionally at least 95%, optionally at least 99% of the dissolved iron ions are ferrous ions.

Aspect 108: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to any preceding Aspect or any combination of preceding Aspects and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) of any preceding Aspect or any combination of preceding Aspects.

Aspect 109: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., according to any preceding Aspect or any combination of preceding Aspects and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) of any preceding Aspect or any combination of preceding Aspects.

Aspect 110: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., described in this instant Application and/or shown in any one or combination of FIGS. 1-8 and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) described in this instant Application and/or shown in any one or combination of FIGS. 1-8.

Aspect 111: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., shown in FIG. 1 and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) shown in FIG. 1.

Aspect 112: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., shown in FIG. 2 and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) shown in FIG. 2.

Aspect 113: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., shown in FIG. 3 and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) shown in FIG. 3.

Aspect 114: A system having any combination of components, parts, systems, subsystems, devices, features, etc., such as but not limited to electrochemical cell(s), tank(s), vessel(s), chamber(s), fluidic connection(s), dryer(s), heater(s), mixer(s), reactor(s), etc., shown in FIG. 4 and/or components, parts, subsystems, devices, features, etc., such as but not limited to electrochemical cell(s), tank(s), vessel(s), chamber(s), fluidic connection(s), dryer(s), heater(s), mixer(s), reactor(s), etc., for facilitating or performing the process(es) and/or step(s) shown in FIG. 4.

Aspect 115: A system or method according to any preceding Aspect, wherein the electrochemical acid-base generator, if present, is according to FIG. 4 or any combination of aspects thereof.

Aspect 116: A system or method according to any preceding Aspect, wherein the first electrochemical cell, if present, is according to FIG. 5 or any combination of aspects thereof.

Aspect 117: A system or method according to any preceding Aspect, wherein the electrochemical acid-base generator, if present, is according to FIG. 6 or any combination of aspects thereof.

Aspect 118: A system or method according to any preceding Aspect, wherein the electrochemical acid-base generator, if present, is according to FIG. 7 or any combination of aspects thereof.

Aspect 119: A system or method according to any preceding Aspect, optionally comprising the cell of FIG. 8 or any combination of aspects thereof.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of any particular claimed invention. Thus, it should be understood that although inventions have been specifically disclosed by preferred embodiments, exemplary embodiments and optional features, modification and variation of the concepts herein disclosed may be resorted to by those skilled in the art, and that such modifications and variations are considered to be within the scope of inventions as defined by the appended claims. The specific embodiments provided herein are examples of useful embodiments of the inventions and it will be apparent to one skilled in the art that the inventions may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including iron oxide materials of an ore or structural and compositional polymorphs of the group members, are disclosed separately. When a Markush group or other grouping is used herein, all individual members of the group and all combinations and sub-combinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every device, system, subsystem, method, process, component, and/or combination of components, described or exemplified herein can be used to practice any claimed invention(s), unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the disclosed devices, systems, methods, and processes pertain. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's inventions, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The claimed inventions illustratively described herein suitably may be practiced in the absence of any element or elements, limitation or limitations which is not specifically disclosed herein.

One of ordinary skill in the art will appreciate that starting materials, reagents, synthetic methods, purification methods, analytical methods, and assay methods other than those specifically exemplified can be employed in the practice of the claimed inventions without resort to undue experimentation. All art-known functional equivalents, of any such materials and methods are intended to be included in these inventions.

We claim:

1. A method of recycling a first slag, comprising:
dissolving the first slag with a first acid to form a starting leachate solution;
wherein the starting leachate solution comprises at least dissolved aluminum ions, dissolved iron ions, dissolved magnesium ions, and dissolved manganese ions;
first precipitating one or more first precipitated products from the starting leachate solution by combining a first base with the starting leachate solution to increase its pH thereby forming a first pre-plating leachate fraction;
wherein the one or more first precipitated products comprise one or more precipitated aluminum-containing products;
wherein the first pre-plating leachate fraction comprises dissolved iron ions, magnesium ions, and manganese ions;
first electroplating metallic iron from the first pre-plating leachate fraction using a first electrochemical cell, forming electroplated metallic iron and a first post-plating leachate fraction;
wherein the first post-plating leachate fraction has a reduced concentration of said iron ions compared to the first pre-plating leachate fraction;
second precipitating one or more second precipitated products from the first post-plating leachate fraction by combining a second base with the first post-plating leachate fraction to increase its pH thereby forming a second leachate fraction;
wherein the one or more second precipitated products comprise one or more precipitated manganese-containing products; and
third precipitating one or more third precipitated products from the second leachate fraction by combining a third base with the second leachate fraction to increase its pH thereby forming a third leachate fraction;
wherein the one or more third precipitated products comprise one or more precipitated magnesium-containing products.

2. The method of claim 1, wherein the first electrochemical cell comprises a first electroplating catholyte, the first electroplating catholyte comprising the first pre-plating leachate fraction, such that the first electroplating catholyte comprises the dissolved iron ions, magnesium ions, and manganese ions.

3. The method of claim 2, comprising separately dosing the first electroplating catholyte with iron hydroxide.

4. The method of claim 2 or 3, wherein the first electroplating catholyte comprises:
dissolved magnesium ions having a concentration selected from the range of 0.01 M to 1.2 M,
dissolved manganese ions having a concentration selected from the range of 0.01 M to 1.2 M, and/or
dissolved calcium ions having a concentration selected from the range of 0.01 M to 1.2 M.

5. The method of any one of the preceding claims, wherein the step of first electroplating metallic iron is performed against an electrochemical oxygen evolution reaction at a first anode.

6. The method of claim 5, wherein a first electrochemical cell comprises the first anode in the presence of a first anolyte, a first cathode in the presence of a first electroplating catholyte, and an anion exchange membrane separating the first electroplating catholyte from the first anolyte;
wherein the first electroplating catholyte comprises the first pre-plating leachate fraction and the metallic iron is electroplated at the first cathode.

7. The method of any one of the preceding claims further comprising:
producing a produced acid and a produced base in an electrochemical acid-base generator;
wherein the first acid comprises the produced acid; and
wherein each of the first base, the second base, and the third base comprises a portion of the produced base.

8. The method of claim 7 comprising:
returning a neutralized salt solution to the electrochemical acid-base generator; and
re-producing the produced acid and the produced base from the neutralized salt solution via the electrochemical acid-base generator.

9. The method of any one of the preceding claims further comprising first providing at least a portion of the first, second, and/or third precipitated products, with or without further processing thereof, to a steelmaking furnace.

10. The method of claim 9, wherein said step of providing comprises converting said provided at least the portion of the first, second, and/or third precipitated products into respective metallic products and/or metal oxide products and then providing said converted respective metallic products and/or metal oxide products to said steelmaking furnace.

11. The method of any one of the preceding claims, wherein the third precipitated products comprise magnesium hydroxide and/or calcium hydroxide; and wherein the method comprises converting the magnesium hydroxide and/or calcium hydroxide to magnesium oxide and/or calcium oxide, respectfully, and providing the magnesium oxide and/or calcium oxide as a flux in a steelmaking furnace.

12. The method of any one of claims 9-11 comprising:
collecting a new steel slag from the steelmaking furnace; and
repeating the method using the new steel slag.

13. The method of claim 12, comprising dissolving the new steel slag in the first or a second acid to form a new starting leachate solution.

14. The method any of the preceding claims, comprising providing at least a portion of the electroplated metallic iron to a steelmaking furnace.

15. The method of any one the preceding claims, comprising producing at least a portion of each of the first acid, the second acid, the first base, the second base, and the third base using an electrochemical acid-base generator.

16. The method of any one of the preceding claims, comprising first collecting at least a portion of a spent catholyte from the step of first electroplating and concentrating the collected spent catholyte.

17. The method of claim 16, wherein the spent catholyte, prior to concentrating, has a dissolved iron ion concentration selected from the range of 0.2 M to 1 M.

18. The method of claim 16 or 17, comprising, after the step of concentrating, a step of Mn-precipitating one or more precipitated manganese-containing products from the concentrated spent catholyte.

19. The method of claim 18, wherein the step of second precipitating comprises the step of Mn-precipitating is the step of second precipitating; wherein the step of Mn-precipitating comprises combining the concentrated spent catholyte with the first post-plating leachate fraction and the base.

20. The method of any one of the preceding claims, comprising:
removing a bleed stream from the first electroplating catholyte.

21. The method of claim 20, comprising:
concentrating the removed bleed stream by reducing its water content; and
fourth precipitating one or more fourth precipitated products from the concentrated bleed stream by adding a fourth base;
wherein the one or more fourth precipitated products comprise magnesium.

22. The method of any one of the preceding claims, wherein a concentration of the dissolved magnesium ions in the first pre-plating leachate fraction is selected from the range of 0.01 M to 1 M.

23. The method of any one of the preceding claims, wherein a concentration of the dissolved manganese ions in the first pre-plating leachate fraction is selected from the range of 0.01 M to 1 M.

24. A method of recycling a first slag, comprising:
dissolving the first slag with a first acid to form a starting leachate solution;
wherein the starting leachate solution comprises at least one or more dissolved aluminum ions, dissolved iron ions, and dissolved calcium ions and/or magnesium ions;
first precipitating one or more first precipitated products from the starting leachate solution by combining a first base with the starting leachate solution to increase its pH thereby forming a first leachate fraction;
wherein the one or more first precipitated products comprise one or more precipitated aluminum-containing products;
second precipitating one or more second precipitated products from the first leachate fraction by combining a second base with the first leachate fraction to increase its pH thereby forming a second leachate fraction;
wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
wherein the one or more third precipitated products comprise one or more precipitated calcium-containing products and/or one or more precipitated magnesium-containing products;
wherein the method further comprises:
producing a produced acid and a produced base in an electrochemical acid-base generator;
wherein the first acid comprises the produced acid; and
wherein each of the first base, the second base, and the third base comprises a portion of the produced base.

25. The method of claim 24, further comprising:
returning a neutralized salt solution to the electrochemical acid-base generator; and
re-producing the produced acid and the produced base from the neutralized salt solution via the electrochemical acid-base generator.

26. A method of recycling a first slag, comprising:
dissolving the first slag with a first acid to form a starting leachate solution;
wherein the starting leachate solution comprises at least one or more dissolved aluminum ions, dissolved iron ions, and one or more dissolved calcium ions and/or magnesium ions;
first precipitating one or more first precipitated products from the starting leachate solution by combining a first base with the starting leachate solution to increase its pH thereby forming a first leachate fraction;
wherein the one or more first precipitated products comprise one or more precipitated aluminum-containing products;
second precipitating one or more second precipitated products from the first leachate fraction by combining a second base with the first leachate fraction to increase its pH thereby forming a second leachate fraction;
wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
wherein the one or more third precipitated products comprise one or more precipitated calcium-containing products and/or one or more precipitated magnesium-containing products;
wherein the method further comprises:
providing at least a portion of the one or more third precipitated products as a flux to a steelmaking furnace and/or reducing at least a portion of the precipitated iron-containing products to metallic iron and using said metallic iron in the steelmaking furnace;
collecting a new steel slag from the steelmaking furnace; and
repeating the method using the new steel slag.

27. The method of claim 26 comprising providing at least a portion of the one or more third precipitated products as a flux to a steelmaking furnace

28. The method of claim 26 or 27, wherein the third precipitated products comprise magnesium hydroxide and/or calcium hydroxide; wherein the method comprises converting the magnesium hydroxide and/or calcium hydroxide to magnesium oxide and/or calcium oxide, respectfully; and wherein the step of providing comprises providing the magnesium oxide and/or calcium oxide as the flux in the steelmaking furnace.

29. The method of any one of claims 26-28 comprising reducing at least a portion of the precipitated iron-containing products to metallic iron and using said metallic iron in the steelmaking furnace.

30. The method of any one of claims 26-29 comprising dissolving the new steel slag in the first acid or a second acid to form a new starting leachate solution.

31. The method of any one of claims 26-30 comprising producing at least a portion of each of the first acid, the second acid, the first base, the second base, and the third base using an electrochemical acid-base generator.

32. The method of any one of the preceding claims, wherein the step of dissolving comprises separating undissolved solids from the starting leachate solution; wherein the undissolved solids comprise silica, titania, and/or calcium sulfate.

33. The method of claim 32, wherein the undissolved solids comprise calcium sulfate; and wherein the method further comprises physically separating the calcium sulfate from other undissolved solids and redissolving the separated calcium sulfate to form solid precipitated calcium hydroxide and an aqueous dissolved sulfate salt.

34. The method of claim 33, comprising returning the aqueous dissolved sulfate salt into an electrochemical acid-base generator.

35. The method of any one of the preceding claims comprising milling the first slag to decrease its particle size prior to the step of dissolving said first slag.

36. The method of claim 34, comprising magnetically separating and removing magnetic components from the milled slag prior to the step of dissolving said first slag.

37. The method of any one of the preceding claims, wherein the first acid comprises one or more weak acids.

38. The method of any one of the preceding claims, wherein the first acid comprises an aqueous bisulfate acid.

39. The method of claim 38, wherein the aqueous bisulfate acid comprises an alkali bisulfate, an ammonium bisulfate, or a combination thereof.

40. The method of claim 38 or 39, wherein the aqueous bisulfate acid is produced using an electrochemical acid-base generator.

41. The method of any one of the preceding claims, wherein the first acid comprises sulfuric acid.

42. The method of any one of the preceding claims, wherein the first acid comprises hydrochloric acid.

43. The method of any one of the preceding claims comprising reducing ferric ions to ferrous ions in the starting leachate solution prior to the step of first precipitating.

44. The method of claim 43, wherein the step of reducing ferric ions to ferrous ions is performed electrochemically.

45. The method of claim 43 or 44, wherein the step of reducing ferric ions to ferrous ions is performed chemically by providing the ferric ions in the presence of a reducing agent.

46. The method of claim 45, wherein the reducing agent is metallic iron, a steel, or another metal comprising iron.

47. The method of any one of claims 43-46, wherein reducing ferric ions to ferrous ions comprises recirculating the leachate solution between a dissolution vessel and a cathode chamber of an electrochemical acid regeneration cell configured to cathodically reduce the ferric ions to ferrous ions while anodically evolving oxygen gas and liberating protons that are transported into the leachate solution in the cathode chamber.

48. The method of any one of the preceding claims, wherein the first base, the second base, the third base, or any combination thereof comprises calcium hydroxide, ferric hydroxide, ferrous hydroxide, metallic iron, and/or magnesium hydroxide.

49. The method of any one of the preceding claims, where each step of first precipitating, second precipitating, third precipitating, or any combination thereof is performed at liquid temperature selected from the range of 50° C. to 90° C.

50. The method of any one of the preceding claims, wherein:
the one or more precipitated aluminum-containing products comprise aluminum hydroxide,
the one or more precipitated iron-containing products comprise iron(II) hydroxide (ferrous hydroxide),
the one or more precipitated calcium-containing products comprise calcium hydroxide, and
the one or more precipitated magnesium-containing products comprise magnesium hydroxide.

51. The method of any one of the preceding claims, wherein the one or more first precipitated products also comprise one or more precipitated chromium-containing products.

52. The method of any one of the preceding claims, wherein the one or more first precipitated products also comprise one or more precipitated phosphorous-containing products or one or more precipitate phosphate-containing products.

53. The method of any one of the preceding claims, wherein the one or more second precipitated products also comprise one or more precipitated manganese-containing products.

54. The method of any one of the preceding claims, wherein the starting leachate solution has a pH less than 2.5.

55. The method of any one of the preceding claims, wherein the first leachate fraction has a pH selected from the range of 2.5 to 4.5.

56. The method of any one of the preceding claims, wherein the second leachate fraction has a pH selected from the range of 6.5 to 9.

57. The method of any one of the preceding claims, wherein the third leachate fraction has a pH selected from the range of 9.5 to 13.

58. The method of any one of the preceding claims, wherein the one or more first, second, and/or third precipitated products comprise metal hydroxide products; and
wherein the method further comprises:
dehydrating at least a portion of the metal hydroxides to form respective metal oxide products.

59. The method of claim 58 comprising using at least a portion of the formed metal oxide products as at least a portion of a flux in the steelmaking furnace.

60. The method of claim 59, wherein the formed metal oxide products comprise magnesium oxide, calcium oxide, and/or aluminum oxide.

61. The method of any one of claims 58-60, wherein the first precipitated products comprise magnesium hydroxide and wherein the method comprises dehydrating the magnesium hydroxide to form magnesium oxide and using the formed magnesium oxide as at least a portion of the flux in the steelmaking furnace.

62. The method of any one of claims 57-59, wherein the third precipitated products comprise calcium hydroxide and wherein the method comprises dehydrating the calcium hydroxide to form calcium oxide and using the formed calcium oxide as at least a portion of the flux in the steelmaking furnace.

63. The method of any one of claims 58-62, wherein the second precipitated products comprise an iron hydroxide and wherein the method comprises dehydrating the iron hydroxide to form an iron oxide, reducing the iron oxide to metallic iron, and using the formed metallic iron in the steelmaking furnace.

64. The method of any one of the preceding claims, wherein the one or more precipitated aluminum-containing products comprise aluminum hydroxide; the method further comprising dehydrating precipitated aluminum hydroxide to form alumina (Al₂O₃) and refining the alumina to aluminum metal in an aluminum smelting process.

65. The method of any of claims 58 to 64, wherein dehydrating is performed using waste heat from a steelmaking plant or a power plant.

66. The method of any one of the preceding claims, wherein the one or more magnesium-containing products comprise Mg(OH)₂ and the one or more calcium-containing products comprise Ca(OH)₂; and wherein the method comprises contacting the precipitated Mg(OH)₂ and/or Ca(OH)₂ with a CO₂-containing gas to form MgCO₃ and/or CaCO₃, respectively.

67. The method of claim 66, wherein the CO₂-containing gas is at a temperature of at least 200° C. during said step of contacting.

68. The method of claim 66 or 67, wherein the CO₂-containing gas is exhaust or flue gas from the steelmaking furnace.

69. The method of any one of claims 66-68, further comprising using the MgCO₃ and/or CaCO₃ as flux in the steelmaking furnace.

70. The method of any one of the preceding claims, wherein the steelmaking furnace is an electric arc furnace.

71. The method of any one of the preceding claims, wherein the first slag is a steel slag or an iron slag.

72. The method of any one of the preceding claims, wherein the first slag is a ladle slag.

73. The method of any one of the preceding claims, wherein the one or more the one or more precipitated calcium-containing products comprise Ca(OH)₂; and wherein the method comprising combining the Ca(OH)₂ with silica, alumina, and iron in a kiln and heating to make clinker.

74. The method of any one of claims 24-73, wherein the one or more second precipitated products comprise magnetite (Fe₃O₄).

75. The method of claim 74 comprising reducing the precipitated magnetite to iron and providing said reduced iron to a steelmaking furnace.

76. The method of any one of claims 24-75, comprising redissolving at least a portion of the one or more metal salts to make a redissolved iron-salt solution; the method further comprising first electroplating metallic iron from the redissolved iron-salt solution.

77. The method of claim 76 comprising first collecting at least a portion of a spent electrolyte from the step of first electroplating and comprising a step of first re-precipitating Fe-containing and/or Mn-containing salts from the collected spent electrolyte.

78. The method of claim 76 or 77 comprising first collecting at least a portion of a spent electrolyte from the step of first electroplating, concentrating the collected spent electrolyte to reduce water content thereof, second electroplating metallic iron from the concentrated spent electrolyte, second collecting at least a portion of spent electrolyte from the second electroplating step, and first re-precipitating Fe-containing and/or Mn-containing salts from the second collected spent electrolyte.

79. The method of any one of claims 24-78, wherein the one or more precipitated iron-containing products comprise Fe(OH)₂.

80. The method of claim 79 comprising heating the Fe(OH)₂ to make FeO.

81. The method of any one of claims 24-80, wherein the one or more iron-containing products comprise iron hydroxide; and wherein the method comprises thermally reducing the iron hydroxide to iron metal.

82. The method of claim 81 comprising using the iron metal to make steel in a steelmaking furnace.

83. A method of electrochemically making metallic iron in the presence of dissolved magnesium and dissolved manganese, the method comprising:
first electroplating metallic iron from a first catholyte at a first cathode against an oxygen evolution reaction at a first anode in the presence of a first anolyte;
wherein the first catholyte comprises dissolved iron ions, dissolved magnesium ions, and dissolved manganese ions;
wherein the first catholyte and the first anolyte are separated by an anion exchange membrane; and
wherein a first electrochemical cell comprises the first cathode, the first catholyte, the first anode, and the first anolyte.

84. The method of claim 83, wherein a concentration of the dissolved magnesium ions in the first catholyte is selected from the range of 0.01 M to 1 M.

85. The method of claim 83 or 84, wherein a concentration of the dissolved manganese ions in the first catholyte is selected from the range of 0.01 M to 1 M.

86. A method of electrochemically making metallic iron, the method comprising:
first electroplating metallic iron from a first catholyte at a first cathode against an oxygen evolution reaction at a first anode in the presence of a first anolyte; and
dosing the first catholyte with iron hydroxide during the step of first electroplating;
wherein the first catholyte comprises dissolved iron ions;
wherein the first catholyte and the first anolyte are separated by an anion exchange membrane; and
wherein a first electrochemical cell comprises the first cathode, the first catholyte, the first anode, and the first anolyte.

87. A method of producing a bisulfate solution, the method comprising:
driving a first sulfate salt solution into an acidifying chamber of an electrochemical acid base generation cell, the first sulfate salt solution having a known concentration of a cations that are counter-ions to sulfate anions in the first sulfate salt solution;
driving a second sulfate salt solution into a basifying chamber of an electrochemical acid base generation cell, the basifying chamber containing a cathode electrode; and
applying an electric current with an applied magnitude across the cathode and an anode of the cell, wherein applying the electric current drives protons into the acidifying chamber at a rate directly proportional to the applied magnitude of the current;
wherein the magnitude of the applied current drives protons into the acidifying chamber at a rate that does not exceed a rate of the cations flowing into the acidifying chamber;
whereby a bisulfate acid solution is formed in the acidifying chamber.

88. The method of claim 87, wherein no more than 0.001 M of sulfuric acid is formed in the acidifying chamber.

89. The method of claim 87 or 88, wherein the cations are sodium cations (Na⁺), lithium cations (Li⁺), or potassium cations (K+).

90. The method of claim 87 or 88, wherein the cations are ammonium cations (NH₄+).

91. The method of any one of claims 87-90, wherein a base solution is produced in the basifying chamber.

92. The method of any one of claims 87-91, further comprising contacting the bisulfate solution with a metallurgical slag material and leaching metallic constituents of the metallurgical slag material into the bisulfate solution.

93. The method of any one of claims 87-92, wherein applying an electrical current to the anode and cathode of the electrochemical acid base generation cell produces hydrogen gas at the cathode; removing the hydrogen gas from the directing the hydrogen gas to the anode; and oxidizing the hydrogen gas to the protons at the anode.

94. The method of claim 93, wherein the anode is a gas diffusion anode.

95. The method of any one of claims 87-94, wherein the electrochemical acid base generation cell has three chambers, the acidifying chamber, the basifying chamber, and a hydrogen oxidation chamber comprising a hydrogen oxidation anode.

96. The method of any one of claims 87-94, wherein the electrochemical acid base generation cell is a two-chamber electrolytic cell.

97. A method of extracting alumina from bauxite ore, comprising:
dissolving the bauxite ore with a first acid to form a starting leachate solution;
wherein the starting leachate solution comprises at least one or more dissolved aluminum ions, dissolved iron ions, and one or both of calcium ions and magnesium ions;
first precipitating one or more first precipitated products from the starting leachate solution by combining a first base with the starting leachate solution to increase its pH thereby forming a first leachate fraction;
wherein the one or more first precipitated products comprise precipitated aluminum hydroxide;
second precipitating one or more second precipitated products from the first leachate fraction by combining a second base with the first leachate fraction to increase its pH thereby forming a second leachate fraction;
wherein the one or more second precipitated products comprise one or more precipitated iron-containing products; and
third precipitating one or more third precipitated products from the second leachate fraction by combining a third base with the second leachate fraction to increase its pH thereby forming a third leachate fraction;
wherein the one or more third precipitated products comprise one or more precipitated calcium-containing products and/or one or more precipitated magnesium-containing products; and
dehydrating the precipitated aluminum hydroxide to form alumina (Al₂O₃).

98. The method of claim 97, comprising:
producing a produced acid and a produced base in an electrochemical acid-base generator;
wherein the first acid comprises the produced acid; and
wherein each of the first base, the second base, and the third base comprises a portion of the produced base.

99. The method of claim 97 or 98 comprising reducing ferric ions to ferrous ions in the starting leachate solution prior to the step of first precipitating.

100. The method of any one of claims 97-99 comprising milling the bauxite ore to decrease its particle size prior to the step of dissolving said bauxite ore.

101. The method of any one of claims 97-100 comprising returning the third leachate fraction to the electrochemical acid-base generator and producing new acid and base from recovered salt in the third leachate fraction.

102. The method of any one of claims 97-101, wherein the step of dehydrating is performed using waste heat from a steelmaking plant, a power plant, or an aluminum smelting plant.

103. The method of any one of claims 97-102, further comprising refining precipitated alumina to aluminum metal in an aluminum smelting process.

104. The method of any one of claims 97-103, further comprising heating at least one precipitated hydroxide to dehydrate the at least one precipitated hydroxide, collecting water released during dehydration, and returning the collected water to the electrochemical acid-base generator, wherein the heating is optionally performed using waste heat from a steelmaking plant, a power plant, or an aluminum smelting plant.

105. The method of any one of claims 97-104, wherein the returned remaining leachate solution is neutralized prior to returning.

106. The method of any one of claims 97-105, wherein the step of dehydrating further comprises condensing water vapor produced by the dehydration and recycling the condensed water to the electrochemical acid-base generator.
